(19) United States
(12) Patent Application Publication
(10) Pub. No.: US 2025/0236928 A1
(43) Pub. Date: Jul. 24, 2025

(54) ELECTRONIC WASTE COMPOSITE ARTICLE OR MATERIAL AND PROCESS FOR MAKING SAME

(71) Applicant: Excir Works Corp., Calgary (CA)

(72) Inventors: Aaron LOGAN, Calgary (CA); Ryan SKINGLE, Calgary (CA); Patrick Robert DERKACZ, Calgary (CA); Hiwa SALIMI, Calgary (CA); Loghman MORADI, Calgary (CA); Jessica Marie MCAVOY, Calgary (CA); Abir Chahrazad Borhot MOUSSA, Calgary (CA); Mahmoud RAJABIAN, Calgary (CA)

(21) Appl. No.: 18/028,662

(22) PCT Filed: Sep. 28, 2021
(86) PCT No.: PCT/CA2021/051351

§ 371 Date: Mar. 27, 2023

Related U.S. Application Data
(60) Provisional application No. 63/084,095, filed on Sep. 28, 2020.

(51) Int. Cl. C22B 11/00; B29B 17/02; C22B 7/00

(52) U.S. Cl. CPC C22B 11/046; B29B 17/02; C22B 7/007; B29B 2017/0268

(57) ABSTRACT

An electronic waste (E-waste) recycling process and composite article or material using the E-waste. E-waste, for example including printed circuit boards (PCBs) and/or electronic components (ECs) such as integrated circuit chips, is size reduced, processed with one or more chemicals to remove base metals, precious metals, and chemicals of concern, and dried to provide a E-waste powder. The E-waste powder, may be used to form an E-waste composite article or material.

### CROSS-REFERENCE TO RELATED APPLICATIONS

This application claims priority to United States provisional patent application number U.S. 63/084,095, filed Sep. 28, 2020, the entire contents of which is hereby incorporated by reference.

### FIELD

The present disclosure relates generally to managing of electronic waste. More particularly, the present disclosure relates to extracting one or more materials from electronic waste and providing an electronic waste composite material or an article made from the electronic waste composite material.

### BACKGROUND

Platinum group metals (PGMs) is a group of elements in the periodic table that includes platinum (Pt), palladium (Pd), rhodium (Rh), ruthenium (Ru), iridium (Ir) and osmium (Os). Ore deposits containing PGMs are generally found with an average concentration of 2-10 ppm (g/t), with hundreds of tonnes of PGMs being produced worldwide from mining and recycled sources (e.g., in 2018, approximately 606.5 tonnes of PGMs were produced).

Gold is an element in the periodic table which belongs to the same group as silver and copper. It is usually found in combination with these metals in ores. The average concentration of copper and silver in Earth's crust is 50 and 0.07 ppm (parts per million) respectively while for gold it is just 0.005 ppm¹.

Ore deposits with a concentration of 0.5 ppm or higher are considered to be economically recoverable. Due to its limited sources, gold recovery not only from ores, but also from secondary sources has become more and more important during the last decades. The annual production of gold from the gold mining industry is more than 2500 to 3300 tonnes worldwide². In addition, about 900 to 1178 tonnes of secondary gold is recovered from different sources such as but not limited to anode slime and jewelry, dentistry and electronic scraps³.

### Application of Platinum Group Metals (PGMs)

PGMs are used in a wide variety of areas due to their unique properties such as strong catalytic properties, thermal stability, resistance to corrosion and high melting points. PGMs are often used as the active part of a catalyst in some common industrial applications such as petroleum refining, chemical and automotive industries. For example, platinum-group metals such as palladium, platinum, and rhodium are used as metallic catalysts in catalytic converters for reduction of harmful gases from vehicle exhaust emissions. Palladium, platinum and rhodium are also used in jewelry, electrical and electronics industry (e.g., in multilayer ceramic capacitors and in computer hard disks to increase storage capacity), as well as investments in the form of bars and coins.

Waste from Electrical and Electronic Equipment (WEEE) or Electronic Waste (E-Waste)

Electronic waste, includes Waste Electrical and Electronic Equipment (WEEE), electronic waste, e-waste, and/or waste products (discarded products, components or materials that are unwanted, have reached their end-of-life or are deemed non-working or obsolete that are destined for reuse, resale, salvage or disposal). Examples of electronic waste include printed circuit boards (PCBs)-virgin and/or populated and/or depopulated, logic boards, random access memory (RAM), integrated circuit (IC) chips, etc.

Advancing technologies and innovation has increased demand and production of electrical and electronic equipment (EEE), which in turn has increased generation of waste from electrical and electronic equipment (WEEE) or electronic waste (e-waste). For example, the global production of e-waste/WEEE includes upwards of 20 to 50 million tons per year of e-waste, and it is expected that these amounts will only increase.

Electrical and E-waste is generally classified as a hazardous material, examples of which include printed circuit boards (PCBs), solder in PCBs, glass panels and gaskets in computer monitors, chip resistors and semiconductors, relays and switches, corrosion protection for untreated galvanized steel plates, decorator or hardener for steel housing, cabling and computer housing, plastic housing of electronic equipment and circuit boards, front panel of cathode ray tubes, motherboards, large/small household appliances, information technology (IT) and telecommunications equipment, electrical and electronic tools, medical devices, lighting equipment, computer monitors, TVs, CPU/hard disk of computers, cables and wires, capacitors, and condensers. Such wastes often contain precious metals (PMs) such as gold (Au), silver (Ag), platinum (Pt), Gallium (Ga), palladium (Pd), tantalum (Ta), tellurium (Te), germanium (Ge) and selenium (Se), which can make it viable for recycling. Generally, pyrometallurgical and hydrometallurgical processes are commonly employed to recover PMs.

Conventional handling of such materials may include thermal incineration and/or burning of WEEE, which may release harmful toxins and/or carcinogens into the surrounding environment. Smelting of WEEE may be used to obtain metals/alloys and sludge(s) for further refining and/or disposal.

Recovery of PGMs from Ore

Extracting PGMs from ore involves smelting, followed by hydrometallurgical refining. Generally, extraction, concentration and purification of PGMs from natural deposits can be capital, time and energy intensive processes that result in significant amounts of solid and liquid wastes. In recovering PGMs from ore, PGM-bearing substances are first crushed and grinded into fine particles. Froth flotation, as a wet chemical treatment, is then applied to produce a concentrate (0.01-0.02% w/w platinum-group elements) which is further dried and smelted in an electric furnace at temperatures, e.g., over 1500° C. The out-coming solid is leached in hydrochloric acid (e.g., 6M) using chlorine gas as oxidant. The aqueous solution is further processed using hydrometallurgical techniques, such as solvent extraction and ion-exchange to produce individual high purity metals.

Metallurgical Processes for the Extraction of Metals from E-Waste

### Hydrometallurgical Processes

Extraction of metals from e-waste can involve hydrometallurgical routes that comprise the steps of acid or caustic leaching for selective dissolution of precious metals from e-waste e.g., using aqua regia for leaching. Generally, the pregnant leach solution is then separated and purified for enrichment of metal content whereby impurities are removed as gangue materials. Isolating the precious metals can be conducted through solvent extraction, adsorption, and/or ion exchange enrichment processes; and recovery of the metals from solution can be conducted through electrorefining (electrometallurgy) or chemical reduction processes. Leaching solutions such as halides, cyanides, thiourea, and thiosulfates are used for leaching of precious metals from their primary ores (for example, see above).

In a hydrometallurgical process, the waste or scrap containing PGMs (for example, from waste autocatalysts or e-waste) is first pre-processed by manually dismantling and isolating individual components containing PGMs. For example the scrap may be shredded into pieces using hammer mills, and metals and non-metals separated using screening, magnetic, eddy current, and density separation techniques. Such screening processes allow for separation of an iron/steel fraction and an aluminum fraction from PGM-containing residue.

The PGM-containing fraction is then further processed using hydrometallurgical, pyrometallurgical, electrometallurgical, or biometallurgical processes, individually or in combination. For example, the processing may consist of solder leaching for separation of a non-metallic fraction and a solder recovery (electrowinning) fraction. PGM-containing residue from the solder leaching is treated by an additional leaching step. Leaching solutions such as aqua regia, halides, cyanides, thiourea and thiosulfates may be used for the leaching or PGMs from their primary ores. PGMs are recovered from the leached solution by cementation, solvent extraction, adsorption on activated carbon or ion exchange methods.

However, there are limitations to hydrometallurgical processes, such as: (i) being a slow and time consuming process; (ii) loss of precious metals during mechanical processing of waste (e.g., loss of upwards of 20%); (iii) using toxic chemicals such as cyanide as a leachant, thereby requiring high safety standards and protocols, to avoid environmental contamination and human health risks; (iv) using halide leachants, which can be difficult to use in such processes due to strong corrosive acids and oxidizing conditions; and (v) there being a risk of further loss of precious metal during subsequent dissolution and separation steps, which impacts the overall metal recovery.

### Pyrometallurgical Processes

Pyrometallurgical techniques include conflagrating, smelting in a plasma arc furnace, drossing, sintering, melting, and varied reactions in a gas phase at high temperatures. Generally, pyrometallurgical processes include the steps of liberation, separation/upgrading, and purification, which are similar to those of hydrometallurgical processes. However, in contrast to hydrometallurgical processes, pyrometallurgical processes do not rely on leaching but rather smelting in furnaces at high temperatures. PGMs may therefore be sorted based on chemical and metallurgical properties. In respect of e-waste management and recycling, smelting in furnaces, incineration, combustion, and pyrolysis is generally used.

An example of a pyrometallurgical process is lead smelting, which involves sintering (ores), reduction, and refining stages. Sintering is carried out to reduce sulfur contents of feed materials. The reduction process is carried out in blast furnaces using coke, from which molten lead (85% purity) can be isolated. In the refining stage, metal and sulfur dross is separated and treated separately (e.g., in a reverberatory furnace). Heating lead dross in a reverberatory furnace leads to the separation of lead bullion (rich in lead), matte (copper and other metals sulfides) and speiss (high in arsenic and antimony contents), wherein the matte and speiss can be treated in copper smelters for the extraction of copper and other metals. When processing e-waste by the lead smelting route, precious metals and other elements are separated from the lead bullion. Precious metals can be separated by forming an insoluble intermetallic compound using zinc (e.g., the Parkes process). Another example of a pyrometallurgical process involves copper smelting routes, which are used to recycle and extract precious metals from e-waste. In copper smelting routes, precious metals are collected in copper matte or black copper. The copper and precious metals are separated from each other via an electrorefining process that produces pure copper metal, with the PMs being separated into slimes. The precious metals are then recovered from the slimes via hydrometallurgical routes.

Limitations of pyrometallurgical processes include: (i) not being able to recover and/or recycle plastics, as they are sometimes used in place of coke as a fuel source; (ii) reduced iron and aluminum recovery, as they end up as oxides in slag phases; (iii) generation of hazardous emissions, such as dioxins, during smelting of certain feed materials (e.g, halogenated flame retardants) requiring special installations to minimize environmental pollution; (iv) high costs of implementing integrated e-waste recycling plants that maximize recovery of valuable metals while also controlling hazardous gas emissions and protecting the environment; (v) burning of fine dust generated from non-metallic portions of e-wastes must be controlled and/or minimized to avoid the health risk posed by fine dust particles; (vi) only a partial recovery and purity of precious metals are affected by pyrometallurgical routes, therefore requiring additional hydrometallurgical and electrochemical techniques to extract pure metals; and (vii) managing smelting and refining is challenging due to the complexity of feed materials and the thermodynamics of possible reactions.

### Processes for Gold Recovery

The most commonly used process for gold recovery from ore includes the use of highly toxic inorganic cyanides (e.g., NaCN, KCN) to convert gold (0) into a water-soluble Au(CN)₂-coordination complex by a process known as leaching.

Generally, following gold dissolution in the cyanide solution, gold is recovered by activated carbon adsorption or by a zinc cementation process. The activated carbon adsorption process is considerably more common^{4,5}.

### WEEE Recycling

Conventional E-waste “recycling” may involve extraction of only gold or other very valuable materials from the E-waste, with the remainder directed to a landfill or a waste burning/incineration facility.

Due to the lack of technology to extract metals and plastics from E-waste, conventional market approach is to incinerate, or burn the e-waste material so that the higher value elements (base metals and precious metals) can be recovered. The plastics, to date, have had little value, and are extremely complicated to purify without the ability to selectively extract base metals (including heavy metals)—thus the materials may be left contaminated with the likes of lead, mercury, arsenic, and other harmful elements.

It is, therefore, desirable to provide a process for recycling electronic waste, by optionally extracting toxic elements and/or base metals, and forming a composite article or material using at least a portion of the electronic waste.

### SUMMARY

It is an object of the present disclosure to obviate or mitigate at least one disadvantage of previous processes for recycling electronic waste.

The present disclosure includes a process for preparing an E-waste powder comprising processing E-waste particles into a slurry, extracting one or more base metal by chemical leaching, extracting one or more precious metal by chemical leaching, and drying the slurry to provide the E-waste powder.

In an embodiment of the present disclosure, the process includes subjecting E-waste to a size reducing step to produce the E-waste particles.

In an embodiment of the present disclosure, the E-waste particles have an average particle size between about 1 and about 1000 microns, between about 100 μm and about 300 μm, between about 100 μm and about 250 μm, or about 250 μm.

In an embodiment of the present disclosure, the E-waste comprises populated printed circuit boards (PCBs), electronic components (ECs), and/or depopulated printed circuit boards (PCBs).

In an embodiment of the present disclosure, the process further comprises leaching the E-waste particles with sulfuric acid, before extracting the one or more base metal and/or before extracting the one or more precious metal.

In an embodiment of the present disclosure, the process further comprises leaching the E-waste particles with hydrochloric acid (HCl) before the drying.

In an embodiment of the present disclosure, the process further comprises forming a composite article or a composite material by combining the E-waste powder and a binder, the E-waste powder and a thermoplastic, the E-waste powder and a thermoset plastic, the E-waste powder and another material, or combinations or subcombinations thereof.

In an embodiment of the present disclosure, the E-waste powder is combined with a plastic, concrete, mortar, or asphalt.

In an embodiment of the present disclosure, the plastic comprises one or more of polypropylene (PP), copolymer polypropylene (CoPP), high density polyethylene (HDPE), urea formaldehyde (UF), polyurethane (PU) and/or other thermosplastic.

In an embodiment of the present disclosure, the process further comprises preparing a masterbatch from the E-waste powder.

In an embodiment of the present disclosure, the process further comprises forming a composite article or material comprising the E-waste powder.

In an embodiment of the present disclosure, extracting one or more precious metal comprises adding one or more chemical to leach at least one of the one or more precious metals into solution and separating the solution and the slurry.

In an embodiment of the present disclosure, the one or more precious metal comprises gold, silver, platinum group metals (PGMs), or combinations thereof.

In an embodiment of the present disclosure, forming comprises blending the E-waste powder with a base plastic for molding the composite article, for example injection molding or compression molding.

In an embodiment of the present disclosure, the composite article comprises a composite board, panel, decking, or structural beam.

In an embodiment of the present disclosure, forming comprises blending the E-waste powder with a binder and hemp to provide the composite material.

In an embodiment of the present disclosure, forming comprises molding, for example injection molding or compression molding.

In an embodiment of the present disclosure, drying comprises one or more of solid-liquid extraction, density separation, filtering, heating, and/or maintaining an elevated temperature for a period of time.

In an embodiment of the present disclosure, the process comprises removing one or more chemical of concern (CoC).

In an embodiment of the present disclosure, the one or more chemical of concern comprises a brominated flame retardant (BFR).

In an embodiment of the present disclosure, a surface treatment is applied to the E-waste powder.

In an embodiment of the present disclosure, the surface treatment comprises applying a coupling agent and/or a compatibilizer.

The present disclosure includes an E-waste powder produced by the disclosed process.

The present disclosure includes an E-waste masterbatch composite produced by the disclosed process.

The present disclosure includes a composite article or composite material produced by the disclosed process.

The present disclosure includes a process for preparing a catalyst waste powder comprising processing catalyst waste particles into a slurry, extracting one or more base metal by chemical leaching, extracting one or more precious metal by chemical leaching, and drying the slurry to provide the catalyst waste powder.

In an embodiment of the present disclosure, the process includes subjecting catalyst waste to a size reducing step to produce the catalyst waste particles.

In an embodiment of the present disclosure, the catalyst waste particles have an average particle size between about 1 and about 1000 microns, between about 100 μm and about 300 μm, between about 100 μm and about 250 μm, or about 250 μm.

In an embodiment of the present disclosure, the process further comprises forming a composite article or material comprising the catalyst waste powder.

In an embodiment of the present disclosure, the catalyst waste powder is combined with a plastic, concrete, mortar, or asphalt.

The present disclosure includes a catalyst waste powder produced by the disclosed process.

The present disclosure includes a composite article or composite material produced by the disclosed process.

As herein described there is also provided:
1. A process for preparing an E-waste powder comprising:
   processing E-waste particles into a slurry;
   extracting one or more base metal by chemical leaching;
   extracting one or more precious metal by chemical leaching; and
   drying the slurry to provide the E-waste powder.
2. The process of item 1, further comprising subjecting E-waste to a size reducing step to produce the E-waste particles.
3. The process of item 2, wherein the E-waste particles have an average particle size between about 1 and about 1000 microns, between about 100 μm and about 300 μm, between about 100 μm and about 250 μm, or about 250 μm.
4. The process of any one of items 1 to 3, wherein the E-waste comprises populated printed circuit boards (PCBs), electronic components (ECs), and/or depopulated printed circuit boards (PCBs).
5. The process of any one of items 1 to 4, further comprising leaching the E-waste particles with sulfuric acid, before extracting the one or more base metal and/or before extracting the one or more precious metal.
6. The process of any one of items 1 to 5, further comprising leaching the E-waste particles with hydrochloric acid (HCl) before the drying.
7. The process of any one of items 1 to 6, further comprising forming a composite article or a composite material by combining:
   the E-waste powder and a binder;
   the E-waste powder and a thermoplastic;
   the E-waste powder and a thermoset plastic; or
   the E-waste powder and another material.
8. The process of any one of items 1 to 7, wherein the E-waste powder is combined with a plastic, or cement or bitumen based composite.
9. The process of item 8, wherein the plastic comprises one or more of polypropylene (PP), copolymer polypropylene (CoPP), high density polyethylene (HDPE), urea formaldehyde (UF) and polyurethane (PU).
10. The process of item 8 or 9, wherein the E-waste powder is combined with a thermoplastic or thermoset polymer.
11. The process of any one of items 1 to 10, further comprising preparing a masterbatch from the E-waste powder.
12. The process of any one of items 1 to 10, further comprising forming a composite article or material comprising the E-waste powder.
13. The process of any one of items 1 to 12, wherein extracting one or more precious metal comprises adding one or more chemical to leach at least one of the one or more precious metals into solution and separating the solution and the slurry.
14. The process of any one of items 1 to 13, wherein the one or more precious metal comprises gold, silver, platinum group metals (PGMs), or combinations thereof.
15. The process of item 12, wherein the forming comprises blending the E-waste powder with a base plastic for injection molding or compression molding the composite article.
16. The process of item 7, wherein the composite article comprises a composite board, panel, decking, or structural beam.
17. The process of item 7, wherein the forming comprises blending the E-waste powder with a binder and hemp to provide the composite material.
18. The process of item 7, wherein the forming comprises injection molding or compression molding.
19. The process of any one of items 1 to 18, wherein the drying comprises one or more of:
   solid-liquid extraction;
   density separation;
   filtering;
   heating; and/or maintaining an elevated temperature for a period of time.
20. The process of any one of items 1 to 19, further comprising removing one or more chemical of concern (CoC).
21. The process of item 20, wherein the one or more chemical of concern comprises a brominated flame retardant (BFR).
22. The process of any one of items 1 to 21, further comprising applying a surface treatment to the E-waste powder.
23. The process of item 22, wherein the surface treatment comprises applying a coupling agent and/or a compatibilizer.
24. An E-waste powder produced by the process of any one of items 1 to 6.
25. A masterbatch composite produced by the process of item 10.
26. A composite article or composite material produced by the process of any one of items 1 to 25.
27. A process for preparing a catalyst waste powder comprising:
   processing catalyst waste particles into a slurry;
   extracting one or more base metal by chemical leaching;
   extracting one or more precious metal by chemical leaching; and
   drying the slurry to provide the catalyst waste powder.
28. The process of item 27, further comprising subjecting catalyst waste to a size reducing step to produce the catalyst waste particles.
29. The process of item 28, wherein the catalyst waste particles have an average particle size between about 1 and about 1000 microns, between about 100 μm and about 300 μm, between about 100 μm and about 250 μm, or about 250 μm.
30. The process of any one of items 27 to 29, further comprising forming a composite article or material comprising the catalyst waste powder.
31. The process of any one of items 27 to 30, wherein the catalyst waste powder is combined with a plastic, or cement or bitumen based composite.
32. A catalyst waste powder produced by the process of any one of items 27 to 29.
33. A composite article or composite material produced by the process of any one of items 27 to 32.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIG. 1 shows a simplified schematic representation of a process of the present disclosure.

FIG. 2 shows a simplified schematic representation of a process of the present disclosure.

FIG. 3 shows a simplified schematic representation of a process of the present disclosure.

FIG. 4 shows a simplified schematic representation of a process of the present disclosure.

FIG. 5 shows a simplified schematic representation of a process of the present disclosure.

FIG. 6 shows a simplified block diagram of the process of the present disclosure, relating to plastic forming.

FIG. 7 shows a simplified block diagram of the process of the present disclosure, relating to plastic injection.

FIG. 8 shows a simplified processing diagram of E-waste and urea formaldehyde (UF) resin for medium density fibreboard (MDF) board and/or thermosetting manufacturing of the present disclosure.

FIG. 9 shows a simplified processing diagram of E-waste/wood or hemp fibers and urea formaldehyde (UF) resin for medium density fibreboard (MDF) board manufacturing of the present disclosure.

FIG. 10 shows a simplified schematic for E-waste powder and polyurethane (PU) reinforced composites of the present disclosure.

FIG. 11 shows a simplified schematic for E-waste powder and a thermoset polymer, for example urea formaldehyde (UF) reinforced composites of the present disclosure.

FIG. 12 shows a simplified schematic of an E-waste reinforced thermoplastic polymer injection molding process of the present disclosure.

FIG. 13 shows an example of size grading of cement additives, including E-waste powder of the present disclosure.

### DETAILED DESCRIPTION

### I. Definitions

Unless otherwise indicated, the definitions and embodiments described in this and other sections are intended to be applicable to all embodiments and aspects of the present disclosure herein described for which they are suitable as would be understood by a person skilled in the art.

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. The term “consisting” and its derivatives, as used herein, are intended to be closed terms that specify the presence of the stated features, elements, components, groups, integers, and/or steps, but exclude the presence of other unstated features, elements, components, groups, integers and/or steps. The term “consisting essentially of”, as used herein, is intended to specify the presence of the stated features, elements, components, groups, integers, and/or steps as well as those that do not materially affect the basic and novel characteristic(s) of features, elements, components, groups, integers, and/or steps.

Terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

The term “and/or” as used herein means that the listed items are present, or used, individually or in any combination (e.g., A, B, . . . X, and/or Y″ refers to “A, B, . . . X, and Y”; or “one of A, B, . . . X, or Y”; or any combination of A, B, . . . X, Y). In effect, this term means that “at least one of” or “one or more” of the listed items is used or present.

As used in this disclosure, the singular forms “a”, “an” and “the” include plural references unless the content clearly dictates otherwise. For example, an embodiment including “a compound” should be understood to present certain aspects with one compound or two or more additional compounds.

In embodiments comprising an “additional” or “second” component, such as an additional or second compound, the second component as used herein is chemically different from the other components or first component. A “third” component is different from the other, first, and second components, and further enumerated or “additional” components are similarly different.

The term “suitable” as used herein means that the selection of specific reagents or conditions will depend on the reaction being performed and the desired results, but none-the-less, can generally be made by a person skilled in the art once all relevant information is known.

The term “precious metal” or “precious metals” as used herein refers to gold and/or platinum group metals, such as platinum (Pt), palladium (Pd), rhodium (Rh), ruthenium (Ru), iridium (Ir) and osmium (Os). In some embodiments, “precious metal” refers to gold, palladium, and/or platinum. In other embodiments, “precious metal” refers to palladium and/or platinum.

The term “base metal” or “base metals” refers to any nonferrous metals that are neither precious metals nor noble metals; for example: copper, lead, nickel, tin, aluminum, and zinc. The term “ferrous metal” or “ferrous metals” refers to metals and alloys comprising iron; for example: steel, alloy steel, carbon steel, cast iron, and wrought iron.

The term “heavy metal” or “heavy metals” refers to any metallic chemical element that has a relatively high density and is toxic or poisonous at low concentrations; for example including but not limited to: Arsenic (As), Beryllium (Be), Cadmium (Cd), Chromium (Cr), Lead (Pb), and Mercury (Hg), and Thallium (TI).

The term “chemical of concern” or “chemicals of concern” or “CoC” refers to chemicals that may pose a threat to human health and/or the environment; for example including but not limited to: cobalt, lead, mercury, cadmium, brominated flame retardants (BFRs), perfluorinated compounds (PFCs), phthalates, and acids.

The term “concrete” refers to a composite mixture of fine aggregate such as sand, coarse aggregate that is larger than about 1 inch, with cement acting as a binder for all phases. Cement may be composed of clinker (sintered lime, silica, alumina, and magnesia), and other additives such as but not limited to gypsum or other pozzolanic materials that, when combined with water, reacts to form a paste that progressively hardens.

The term “mortar” refers to a mixture of fine aggregate and cement as a binder with a water content higher than that of concrete, for workability.

The term “asphalt” refers to a mixture of bitumen with sand or gravel used for construction.

### II. Recycling of Electronic Waste, and a Composite Article or Material Therefrom

Generally, the present disclosure provides a process for recycling electronic waste and/or providing an article or material derived from the electronic waste.

### Overview

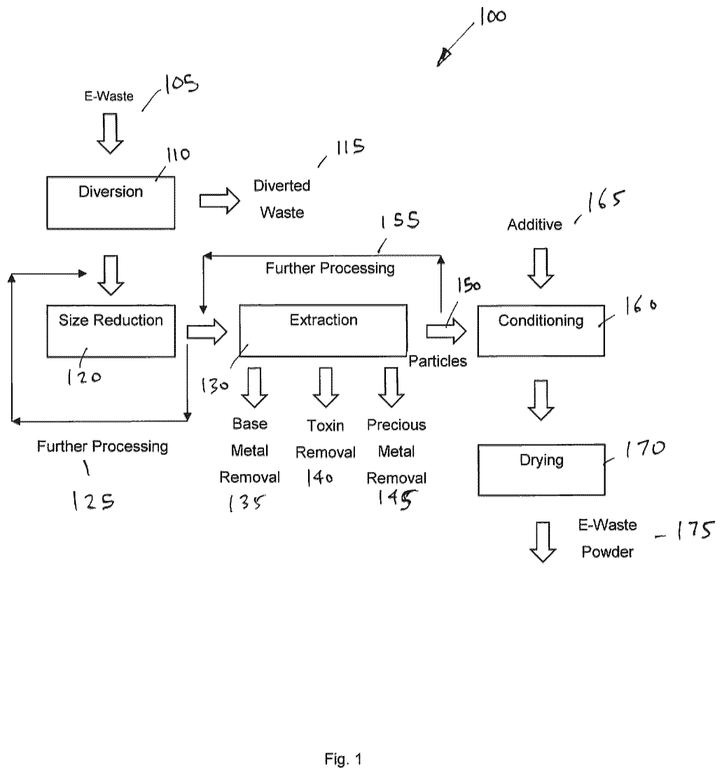

Referring generally to FIGS. 1, 6 and 7, E-waste is size reduced, processed to remove base metals, precious metals and CoC, and dried to provide an E-waste powder.

As further described below, in an example process 100 of FIG. 1, E-waste 105 is subject to size reduction 120, and for example may undergo addition rounds of further processing 125. Then the E-waste goes through base metal removal 135, toxin or CoC removal 140, and/or precious metal removal 145. The order shown is only an example and the steps need not be done in the order shown. An additive 165 may be optionally added, and the stream optionally conditioned 160. Upon drying 170, e-waste powder 175 is provided.

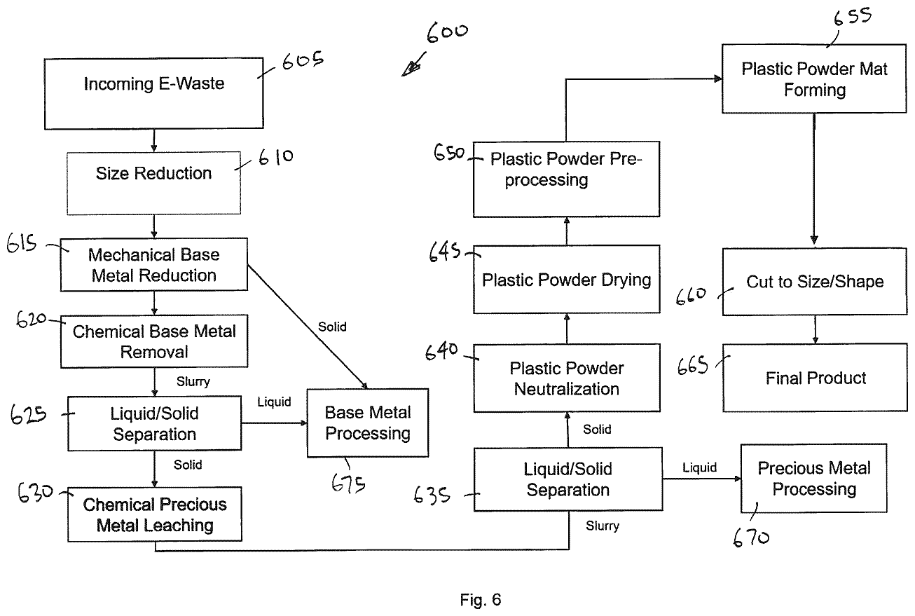

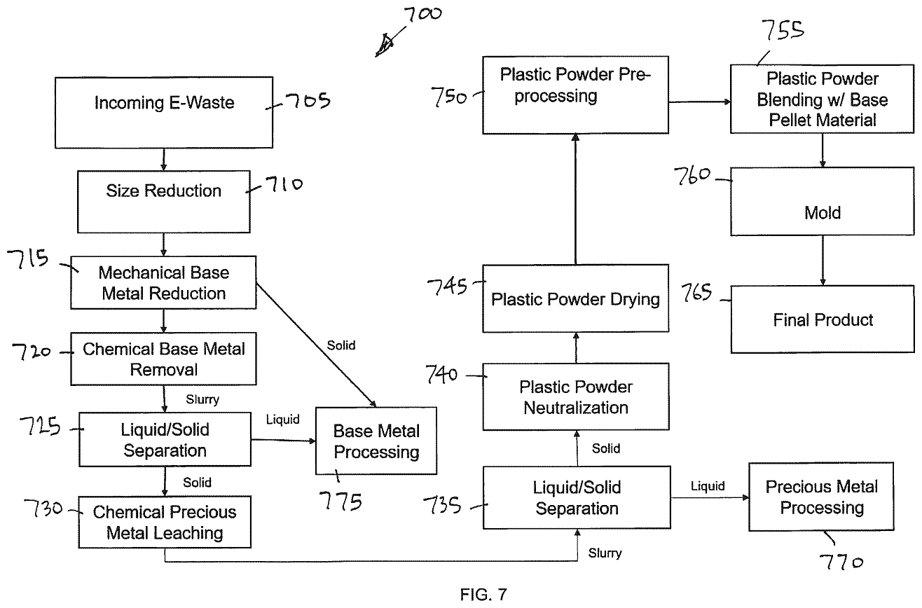

As further described below, in an example process 600 of FIG. 6 or 700 of FIG. 7 incoming E-waste 605/705 undergoes size reduction 610/710, mechanical base metal reduction 615/715, chemical base metal removal 620/720, liquid/solid separation 625/725, chemical precious metal leaching 630/730, liquid/solid separation 635/735, plastic powder neutralization 640/740 and plastic powder drying 645/745 to provide e-waste powder.

In the example process 600 of FIG. 6, e-waste powder is pre-processed 650, and goes through a plastic powder mat forming 655, followed by cut to size/shape 660 to provide a final product 665. Base metal processing 675 and precious metal processing 670 are described below.

In the example process 700 of FIG. 7, e-waste powder is pre-processed 750, and goes through a plastic powder blending with base pellet material 755, followed by molding 760 to provide a final product 765. Base metal processing 775 and precious metal processing 770 are described below.

The E-waste powder may be used as an additive for a composite polymer to form a composite article or composite material. The composite may be, for example, a thermoplastic or a thermoset composite. The thermoplastic may be, for example, polypropylene (PP), polypropylene copolymer (CoPP) or high density polyethylene (HDPE). The thermoset composite may be, for example, urea formaldehyde (UF) or polyurethane (PU).

The E-waste powder may be used as an additive to a cement, mortar, or asphalt.

### Electronic Waste

Electronic waste, from consumer, industrial or other sources is collected or received for processing.

Electronic waste may comprise composite materials made up of, for example, gold, copper, silver, substrates (e.g. plastic, polymers, laminate, polyamide resin, with or without fillers, fiber-reinforced plastic, e.g. using glass fibers, such as fiberglass or glass-reinforced epoxy laminate, e.g. NEMA G-10/G10 or flame retardant, e.g. NEMA FR-4/FR4) as well as metals and other components.

In some embodiments the electronic waste comprises populated printed circuit boards (PCBs) that have been removed from electronic devices such as computers, phones, industrial telecommunication towers, or the like.

In an embodiment disclosed, E-waste may comprise one or more of populated printed circuit boards (PCBs), depopulated printed circuit boards (PCBs), and integrated circuit (IC) chips.

### Diversion

The electronic waste may vary in composition and/or quality, particularly after collection, storage and/or transport.

In some embodiments, a portion of non-electronic waste or electronic waste contaminated with non-electronic waste or other undesirable material is removed or otherwise diverted before processing the electronic waste. Such non-electronic waste may include, for example, organic matter, garbage or other contaminants. In some embodiments, the diverted waste may also contain one or more of, for example, lead, electronic waste containing unacceptable levels of mercury, arsenic, polychlorinated biphenyls (PBs), asbestos, carcinogens, mutagens or radioactive electronic waste according to the presently disclosed process. In some embodiments undesirable materials may include, for example, Li-ion batteries and/or rare earth magnets.

### Preparation

The electronic waste is prepared for processing in one or more preparation stage.

Larger metallic components that are easiest to remove can be removed first, such as heat sinks, connectors, components mounted to the PCBs, etc. This process can be conducted by running the electronic waste through a de-soldering machine to separate components from the PCBs for separate processing. There is no need to subject large metallic components to size reduction (see below), for example homogeneous materials, such as aluminum or copper heat sinks for example.

### Size Reduction

In some embodiments, preparation of the electronic waste includes subjecting the electronic waste to a size reducing step to produce electronic waste particles. The size reducing step may include one or more stages of shredding and/or grinding and optionally one or more stages of chemical and/or mechanical treatment and/or sorting processes before, between or after the size reducing step(s).

In some embodiments, the electronic waste is sized reduced to provide electronic waste particles have an average particle size between about 1 and about 1000 microns. In an embodiment disclosed, the electronic waste is size reduced to between about 100 μm and about 300 μm, between about 100 μm and about 250 μm, or about 250 μm.

In an embodiment disclosed, E-waste materials are subject to one or more of shredding, crushing, grinding, milling and/or hammering, resulting in a particle size distribution including at least material A, material B, and dust. The dust may be separated from material A and material B, for example by an air separator and the dust collected. Material A and material B may be separated, for example by an electrostatic separator. Material A may be substantially metal powder. Material B may be substantially non-metal powder.

Size reduction is somewhat variable, and in some embodiments disclosed, size reduction provides a particle size distribution with a fraction of larger/oversize “coarse” particles and a fraction of smaller/undersize “fine” particles. In some embodiments disclosed, the coarse particles may be used as a fine aggregate replacement or supplement/additive in concrete or mortar, while the undersize fraction may be used as an additive in polymers.

While E-waste, such as populated PCBs, may be processed substantially as-is or as-pulled from electronic equipment. In an embodiment disclosed, the populated PCBs are at least partially or substantially depopulated. PCBs may be populated with electronic components (ECs), for example but not limited to integrated circuit (IC) chips, capacitors, resistors, etc. In an embodiment disclosed, the E-waste is separated into an electronic components (ECs) stream comprising electronic components removed from the PCBs, and a PCB stream comprising the depopulated PCBs. On a commercial scale, depopulating PCBs may be achieved via low temperature heating in a rotary furnace. The heat melts the solder that secures the ECs to the PCB and when combined with the rotation of the drum in the rotary furnace, the ECs and PCBs are easily separated. This multi-stream (e.g. two-stream) approach is more efficient for both size breakdown and chemical processing as PCBs are, relatively speaking, more difficult to break down compared to ECs.

In an embodiment disclosed, one may be selective with the type of E-waste additive used in the composite material, for example, E-waste may be limited or selected to include one or more of only PCB material, only capacitors, only ECs, only ICs etc. or may be a blend of one or more type of E-waste constituent. In an embodiment disclosed, different mechanical properties or resulting composite materials may be achieved by varying these parameters. In an embodiment disclosed, E-waste processed or selected to comprise substantially only electronic components (ECs), may be used to produce electronic component powder (ECP) and/or E-waste processed or selected to comprise substantially only integrated circuit integrated circuits (ICs) to produced integrated circuit chip powder (ICCP) and/or E-waste processed or selected to comprise substantially only PCBs, may be used to produce PCB powder.

The EC stream (e.g. containing IC chips), is relatively friable, and is broken down through size reduction, for example via ball milling. In an embodiment disclosed, greater than about 50%-70% of the material is less than a selected particle size. In an embodiment disclosed, the selected particle size is about 250 μm. In an embodiment disclosed, at least a portion of the material is subject to further size reduction, e.g. milling, to increase the amount of material that meets the selected particle size.

The PCB stream is broken down through size reduction, for example via one or more passes through a hammer mill, followed by ball milling. In an embodiment disclosed, at least a portion of the material passes through a selected mesh size. In an embodiment disclosed, the selected mesh size is about 250 μm. In an embodiment disclosed, at least a portion of the material is subject to further size reduction, e.g. milling, to increase the amount of material that meets the selected mesh size.

The hammer mill functions with a high-speed rotation of metal ‘hammers’, and a ball mill uses a cascade of heavy balls. The rotating hammers of the hammer mill create both a high impact force on the PCBs as well as a vortex to induce particle to particle interaction to break down the PCBs. By separating the hammer mill size reduction into multiple-stages, it allows for the optimization of the hammer mill parameters based on the feedstock. In some embodiments, a lower speed, e.g. revolutions per minute (RPM), is used for larger PCBs to allow the PCBs to penetrate closer to the rotor of the hammer mill and not float atop the rotating hammers, whereas a finer feed can utilize a higher speed, e.g. revolutions per minute (RPM) since a finer material/powder will not float atop in the same manner. Multiple-stages of hammer milling and/or ball milling may be provided. In an embodiment disclosed, two or more stages are provided. The multiple-stages may be provided by a multiple-stage mill or single stage mills arranged in sequence or a combination thereof.

The ball mill may use a plurality of heavy balls, of differing sizes, e.g. 60 mm, 80 mm, 100 mm, and 120 mm diameter mixed balls that provide impact forces to further break down PCB material after the second run in the hammer mill or break down the ECs.

In an embodiment disclosed, the EC stream and the PCB stream have a final size reduced target size of about 250 μm for further mechanical and chemical processing. In an embodiment disclosed, the average particle size for the EC stream is between about 50 μm and about 1500 μm. In some embodiments disclosed, higher or maximum metal extraction is achieved using material below a 250 μm particle size. Therefore, in some embodiments, a demarcation size between fine and coarse fractions is selected as about a 250 μm particle size.

In an embodiment disclosed, the output from the hammer mill is sieved, for example through a gyratory separator, such as a Russell Finex Separator, using a selected screen. In some embodiments the selected screen is a 60 mesh/250 μm screen. One notable advantage to ball mill is that much of the bare base metals and copper wires from the ECs remain substantially intact and are retained by the selected screen with the coarse fraction from the separator, effectively removing them from the fine fraction, which reduces unwanted base metals in the E-waste powder.

In an embodiment disclosed, an electrostatic separator may be used to separate one or more streams into a metal fraction and a plastic containing/non-metal fraction, which allows for more efficient base metal and precious metal removal and provides a plastic containing/non-metal fraction with less metal content.

### Coarse Fraction

The size reduction phase is efficiently able to break down over about 80% of the E-waste PCBs to a size less than 250 μm, though there is still a fraction of the E-waste that is larger than 250 μm and less optimal for precious metal leaching (below). This fraction may be between about 250 μm and about 500 μm such as about 400 μm on average and contains very little gold and other precious metals.

In an embodiment disclosed, the ‘coarse’ fraction may be subject to further size reduction. In an embodiment disclosed, the oversize fraction, >250 μm may be processed to remove CoCs via leaching and may be used as a sand/fine aggregate replacement or supplement/additive in concrete or mortar owing to its high silica content and size distribution. By substituting or adding E-waste powder for/with sand, reliance of mortar/concrete producers on sand is reduced and a use for the E-waste by-product is provided. The coarse fraction may also be used as a polymer additive, for example for MDF composites.

### Fine Fraction

In an embodiment disclosed, the E-waste powder that is <250 μm is leached with sulphuric acid to remove base metals (primarily copper), followed by one or more process, such as leaching, for precious metal recovery, and then a hydrochloric acid leach to remove lead, remaining base metals, and chemicals of concern (CoC).

### Extraction

In one or more extraction stage, one or more recoverable metals are removed from the electronic waste particles. The one or more recoverable metals may include one or more base metal and/or one or more precious metal and/or one or more heavy metal. The recoverable metals may include, for example, platinum and/or platinum group metals (PGMs), gold, copper, silver, iron, lead, tin and combinations thereof.

The powdered E-waste material is processed with one or more leach processes for base metal recovery, precious or semi-precious metal recovery, and CoC and lead removal. The order of leach operations is not fixed, and in an embodiment disclosed, the leaches processes may be applied in any order and permutations thereof.

In an embodiment disclosed, base metal and silver leaching may be one of the first steps of the chemical treatment process. The process may include a nitric acid (HNO₃) treatment to remove one or more base metal, such as copper and/or a sulphuric acid (H₂SO₄) treatment which removes a high percentage, e.g. more than about 99%, of copper and a significant percentage, e.g. up to about 80%, of silver.

Although there are significantly more base metals by weight, the recovery of precious metals is an economic driving force for E-waste recycling, with over 80% of the total value attributed to gold alone. Gold, palladium, and silver are the main precious metals that are found in E-Waste and can currently be economically recovered.

After the H₂SO₄ treatment, gold and palladium are leached from the E-waste powder. The precious or semi-precious metals may be removed by leaching or other processes. One such process includes leaching of gold using cyanide. Additional examples of such processes are described in WO 2016/168930, titled “Methods for Simultaneous Leaching and Extraction of Precious Metals”, WO 2016/168933 title “Methods for Selective Leaching and Extraction of Precious Metals in Organic Solvents”, and/or PCT/CA2021/051102 titled “Methods for Leaching and Recovery of Platinum Group Metals in Organic Solvents”, each of which are incorporated herein in their entirety by reference thereto for all purposes.

After the precious or semi-precious metals are removed, the E-waste particles may then be subjected to a hydrochloric acid (HCl) leach to remove lead and/or remaining base metals.

In the extraction stage, one or more toxins or heavy metals are removed from the E-waste particles. The material is then neutralized and rinsed. Neutralized may include, for example, pH adjustment up or down to neutralize the pH.

In an embodiment disclosed, the process(es) may be batch, semi-continuous or continuous process(es).

### Heavy Metals and Chemicals of Concern (CoC)

The leach process (base metal, precious metal, heavy metal) in succession removes significant CoCs. In an embodiment disclosed, CoCs are substantially removed.

### Flame Retardants

High concentration of brominated flame retardants (BFRs), mainly polybrominated diphenyl ether (PBDE) and tetrabromobisphenol A (TBBPA) may be added to plastic matrices during the manufacture of PCBs to increase flame resistance, and therefore may be present in E-waste.

Brominated flame retardants (BFRs) are the most prevalent type of flame retardant. There are two main groups of BFRs: ones that are added to the polymer as a mixture additive, and ones that are reactive and incorporated into the polymer backbone; the former has potential to leach into the environment, and the latter are unable to be leached and have been reported as posing no threat to human health by multiple government authorities worldwide⁶. The BFR's most commonly found in E-waste are tetrabromobisphenol-A (TBBPA), polybrominated diphenyl ethers (PBDE), and hexabromocyclododecane (HBCD).

The expected BFR remaining after leaching is TBBPA as it is the most common BFR in E-waste and is stable within the polymer backbone. PBDE and HBCD are the second and third most used additive flame retardants in E-waste, respectively⁷.

Other flame retardants include polychlorinated biphenyl (PB) compounds, but they do not leach into the environment after chemical processing.

The amount of flame retardant may be reduced, for example through ball milling, leaching and/or a solvothermal process⁸.

One or more ball milling step on the E-waste or plastic stream with iron powder may be used to remove at least some of the BFRs. Iron, as an electron donor, transfers electrons to pentabromodiphenyl ether molecules in BFRs during ball-milling. The C—Br bond is stretched, and the bond length increased, which promotes the debromination process. FeBr₂ and non-brominated resins are the main products and the plastics remain largely unchanged. The stream may be washed with water to remove and recycle FeBr₂.

A further step in the form of a solvothermal process or acid, e.g. HCl leaching, may be used to remove additional flame retardants, subsequent to the above ball milling.

The solvothermal process may include mixing the milled plastic stream (after base metal, precious and heavy metal extraction) with alcohol solvents, such as one or more of methanol, ethanol and isopropanol at high temperature. The solvent extracts brominated flame retardants (BFRs) from the plastic macromolecules. Then, the solvent containing flame retardants is separated from the plastic portion. Finally, by adding metallic copper to the organic solvent, bromine is removed resulting in bisphenol and copper bromide as the main products which may be handled safely.

As between PCBs and EC chips, bromine present in E-waste may be at higher concentration in PCBs and at lower concentrations in EC chips. Referring to Table 1 below, indicating the presence of bromine in example E-waste using XRF, pulverized EC chips and PCBs, and the bromine therein, an example of the different bromine (Br) levels and reduction is shown. “Chips” in Table 1 below refers to EC chips, e.g. ECP.

TABLE 1

| | | Corrected Br | Percentage |
|---|---|---|---|
| | | accounting | reduction in Br |
| | Total | for mass loss | after metal |
| | Br | in processing | extraction |
| Powder Type | (ppm) | (ppm) | (mass corrected) |
| chips in (<250 μm) | 2596 | 2596 | |
| powder form, untreated | | | |
| chips in (<250 μm) | 2477 | 619 | 76% |
| powder form, all | | | |
| metals extracted | | | |
| PCB (<250 μm) | 59752 | 59752 | |
| powder, untreated | | | |
| PCB (<250 μm) | 61996 | 40917 | 32% |
| powder, all metals | | | |
| extracted | | | |

When correcting for mass loss, it is noted that there is a reduction in bromine after the metal extraction stages, and the rest of the remaining bromine is assumed to be stable as it is not removed after multi-step acid metal extractions.

This inability to be leached is indicative of bromines' stability within the polymer backbone, as well as its stable behaviour in acidic environments. The leaching process leaches the mobile BFRs and leaves the chemically stable ones bonded to the polymer backbone, so it does not alter the polymer structure for further processing.

The stability of TBBPA has also been tested by the European Union Institute for Health and Consumer Protection who have stated that there are no health effects of concern identified⁹.

### Flame Retardant as a Benefit

If the material or article to be formed from the E-waste powder requires or permits the presence of flame retardants, then the flame retardants can be left in the E-waste powder to act as a contributing media to the fire resistance of the end product.

### Slurry

After the above size reduction, removal of recoverable base metals and/or precious metals and/or heavy metals and CoCs, the E-waste has been reduced to a viscous mixture of liquid and solid components as a sludge of mixed plastic, ceramic, and fibers (e.g. glass) and liquid(s) (e.g. leaching agent and/or lixivant) containing metals in solution.

### Separation

A primarily liquid portion and a primarily solid portion are separated, for example by mechanical separation using a filter or the like. The primarily liquid portion, e.g. leaching agent and/or lixivant containing metals in solution is treated for extraction of the metals by conventional means such as electrolysis, chemical reaction, or pyrolysis.

A neutralizing agent and/or a rinse (e.g. water) may be used to remove traces of chemicals from the mixed media solids/sludge.

### Material Preparation—E-Waste Powder

The solids/sludge is then prepared by one or more of dewatering, centrifuge, decanting and/or drying to provide a dry E-waste plastic, ceramic, and fiber powder. The resulting net by-product after metals extraction processes typically contains fumed silica and glass particles, as well as epoxy resins and other ground thermoset polymers containing flame retardants with less than about 5% unextracted metals remaining. The stream after metal extraction stages is chemically neutralized and washed to ready it for use as a filler in polymer processing.

The dry E-waste powder is then ready to be used to make a composite article or composite material.

### Thermogravimetric Analysis (TGA) of E-Waste Powder

TGA is the measurement of a material sample's thermal stability and works by measuring the mass change with incremental increases in temperature. TGA is a valuable tool for characterization of the powder for it gives information about the optimal processing and manufacturing temperature to ensure the polymer fraction will not degrade when heated, in addition to giving the relative proportion of silica in the mix. Understanding the makeup of the ICCP allows for better prediction about how the mechanical properties of the polymer will be altered with its addition into a polymer matrix.

The data obtained from the TGA suggest the EC powder, after precious and base metal leaching, contains between about 15 to about 30 wt % thermoset polymer with the rest being solid particles. Based on the TGA, the E-waste should be maintained below 220° C. to avoid degradation of the polymer. In an embodiment disclosed, this will also limit thermoplastic choices with thermal transition (i.e., melting point).

### Fourier-Transform Infrared Spectroscopy (FTIR)

FTIR spectra of ECP revealed that the E-waste is composed of fumed silicate particles encapsulated by the thermosetting polymer resin, with a small percentage of additives such as BFRs.

The dried, decontaminated fine powder is composed of mainly epoxy and silica, and may be used as a property enhancement additive in a polymer composite. The combination of a dispersed harder, stronger phase within the polymer matrix improves the overall mechanical properties of the composite as some of the stress the polymer matrix bears can be transferred to the dispersed powder phase.

The resulting purified substantially non-metallic concentrate powder may be used as an additive in thermoplastics such as polypropylene (PP), polypropylene copolymer (CoPP), and high-density polyethylene (HDPE), to help increase mechanical properties of the base material and/or provide a use for the e-waste byproduct. It will also be beneficial when used to produced thermosetting materials improving their final mechanical and thermal resistivity properties, such as a thermoset plastic, for example, urea formaldehyde (UF) or polyurethane (PU). The E-waste powder may also be used as an additive for cement based composites and/or asphalt/bitumen based composites.

### Conditioning

The E-waste powder may be conditioned by addition of one or more additive. In an embodiment disclosed, the one or more additive includes additional substrate material, e.g. fiber-reinforced plastic, e.g. using glass fibers, such as fiberglass or glass-reinforced epoxy laminate, or glass filled thermoplastics and engineered polymers. In an embodiment disclosed, the one or more additive includes one or more virgin plastic.

In an embodiment disclosed, the one or more additive includes flame retardant free dilution, for example additional recycled or virgin materials without flame retardant, in order to reduce the overall percentage amount of flame retardant in the combined material.

In an embodiment disclosed, plastics from other sources, such as recycled plastics may be added to the E-waste powder to form part of the filler material that dilutes the flame retardant concentration and/or act and/or contribute to a binding agent to the powder. For example, some of the plastics that are more difficult to recycle due to labeling or package design, such as plastic clam shell packaging such as polyethylene terephthalate (PET).

The added materials could be any one of, or more than one of the following readily available recycled plastics:
1. Polyethylene terephthalate (PET, PETE)
2. High-density polyethylene (HDPE)
3. Polyvinyl chloride (PVC)
4. Low-density polyethylene (LDPE)
5. Polypropylene (PP) Report.
6. Polystyrene (PS).
7. Other plastics, for example polycarbonate or acrylonitrile butadiene styrene (ABS).

### Surface Treatment of E-Waste Powder

In an embodiment disclosed, a powder surface treatment may improve bond strength within the thermoplastics between the E-waste powder and the polymer, further increasing mechanical properties. This treatment may improve the tensile strength and/or hardness of the polymers, along with the dispersion of the E-waste powder within the polymer.

Final mechanical properties of polymer composites depend on the interfacial properties and bonding between the reinforcement fillers and the polymer matrix¹⁰. Modification of the E-waste surface was determined to be beneficial based on its dispersion within the matrix with the added benefit that strength could be improved after treatment.

Coupling agents can react with SiO₂ on the surface of fumed silicate powder to improve wettability of the fumed silicate/glass fibres in the E-waste as this property is critical in determining mechanical performance.

Wettability is defined as the attraction of a liquid phase to a solid surface, in this case it is for example the attraction between the ECP and the polymer matrix¹¹. Maleic anhydride grafted compatibilizers may also be used to improve dispersibility and bonding of E-waste to polymer by bridging functional groups. The grafted coupling agent on the E-waste particles form bonds with the compatibilizer, which is grafted to the polymer.

Compatibilizers are compounds that promote interfacial adhesion between polymers that are usually immiscible, whereas coupling agents improve the interfacial properties of inorganic fillers by reacting with their surface and having a secondary group that reacts with the polymer matrix to improve compatibility¹². The abundant functional groups of coupling agents grafted on to the E-waste surface form bonds with the compatibilizer functional groups, which further interact with the polymer chains. As a result, the spherical particles are coated, preventing the particle-particle interactions within the composite, while the polymer and particle interactions are improved.

The surface of the E-waste powder can be modified with a coupling agent to improve the filler/matrix interfacial adhesion when melt-mixed with the polymeric matrices. The surface modification at relatively mild conditions was done to avoid any damage to the E-waste. Additionally, less than about 6 wt % compatibilizer was found to be adequate for the surface treated E-waste, and improved all mechanical properties tested.

After the surface treatment process, it is apparent from the scanning electron microscopy (SEM) images that there is interfacial adhesion and chemical bonding across the interfacial area of the E-waste powder in the polymer matrices. The ductile nature of some polymers allows it to spread on the surface-treated E-waste substrate, resulting in complete wetting and a strong bond to the particles, as well as better dispersion and reduced likelihood of agglomeration of the small sized particles.

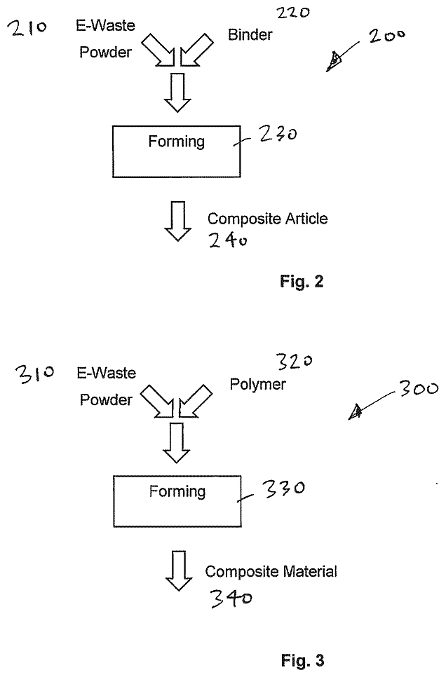

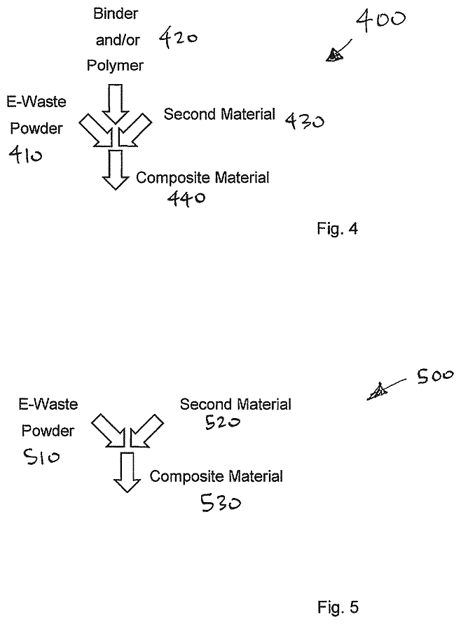

Referring to FIGS. 2-5 generally. In an example process 200 of FIG. 2, E-waste powder 210 and binder 220 are combined and composite article 240 provided by forming 230. In an example process 300 of FIG. 3, E-waste powder 310 and polymer 320 are combined and composite material 340 provided by forming 330. In an example process 400 of FIG. 4, E-waste powder 410 and binder and/or polymer 420 are combined with second material 430 to provide composite material 440. In an example process 500 of FIG. 5, E-waste powder 510 and second material 520 are combined to provide composite material 530.

### Forming Composite Article

The E-waste plastic, ceramic, and fiber powder may be combined with a binding agent or blended with a polymer, for example one or more of acrylonitrile butadiene styrene (ABS), polypropylene (PP), polypropylene copolymer (CoPP), polyethylene (PE), thermoplastic elastomers (TPE), polyvinyl ethers (PVE), etc. to make a composite article.

### Polymer Based Product

Due to the large array of possibilities, and the wide variety of reinforced composite end-products, in an embodiment disclosed a use for this composite is to create a raw material in the form of an E-waste filled (e.g. about 10-80 wt %) thermoplastic or masterbatch (MB). A MB is a highly concentrated mixture (e.g. greater than about 40 wt %) of an additive encapsulated in a carrier polymer. In an embodiment disclosed, ECP may be the additive carried in polymer matrices in the form of pellets that can be diluted with a suitable polymer by the user/manufacturer.

In an embodiment disclosed, a polymer composite and masterbatch production process for masterbatch manufacturing of pellets from E-waste is provided. E-waste powder, provided as described herein, is treated in a surface treatment reactor to provide treated E-waste powder. The reactor may include a rotary agitator, powered for example by a motor to stir the reactor contents, and a cooling/heating jacket may be provided to draw heat from or provide heat to the reactor contents. The surface treated E-Waste powder is dried, for example at elevated temperatures for a period of time, for example about 24 hours. The dried, surface treated E-waste powder may be mixed with one or more polymer, for example HDPE or PP, in a feeder to feed a compounder. The compounder may be for example a screw extruder, and the compounded material extruded through a die to provide hot strands of E-waste/PP/HDPE composites. The hot strands may be cooled, for example in a water bath, and then a pelletizer provides E-waste/PP/HDPE composites in pellet form.

In an embodiment disclosed, the pelletizer may be replaced with a cutter, to provide a polymer composite and masterbatch production schematic process for masterbatch manufacturing of boards, decking, building material, or other articles.

Some of the advantages of a masterbatch (MB) over conventional filler addition into polymer are that it is more efficient, as well as provides improved mechanical properties as reprocessing and dilution lead to better filler dispersion within the polymer composites. Because these commodity polymers (HDPE and PP) are in such high demand, replacing even 30% may results in a significant reduction of carbon emissions and reuse of plastics.

### Urea Formaldehyde (UF) Composite/MDF/Building Materials, and Polyurethane (PU) Composite.

In an embodiment disclosed, E-waste powder may be used to form composite building materials, for example MDF type materials. As an example, see Example 2 below.

### Cement Based Product

The E-waste powder may be used as an additive to cement or mortar.

In an embodiment disclosed, the oversize fraction, about ≥250 μm after being processed to remove CoCs via leaching may be used as a sand/fine aggregate replacement or supplement/additive in concrete or mortar owing to its high silica content and size distribution. By substituting or adding E-waste powder for/with sand, reliance of mortar/concrete producers on sand is reduced and a use for the E-waste by-product is provided.

The use of E-waste in a concrete masonry unit allows for use within a multitude of applications, inexpensively. The replacement of any fraction of the fine aggregate (sand) allows for a significant drop in the need for imported or mined sand, and because it is a waste by-product of the process, there is also a cost saving factor.

Cement based composite products whereby the E-waste may be incorporated into includes but is not limited concrete masonry units (CMUs)/cinder blocks, decorative cement formulations, structural cement formulations, mortars, low pH/limestone/magnesium cement formulations, vinyl or other concrete mixes, bitumen containing cement mixing such as asphalt, hydraulic/underwater applications for structural or decorative uses, in sand mix, with Portland or quick set cement mix, driveway/sidewalk repair formulations, and other paving applications. Applications of formulations may create products such but not limited to sidewalks/driveways, furniture, CMUs, curbs, flooring, fountains, statues, and patio bricks.

### Catalyst Powder (“Cat Powder”) Cement Products

While the above is described in relation to processing of E-waste to provide E-waste powder for composite materials and/or products, catalyst powder (“cat powder”) may be processed in a similar manner to provide a catalyst powder similarly useful as a sand/fine aggregate replacement or supplement/additive for concrete or mortar or as a polymer additive.

Waste catalysts may arise from, for example industrial catalysts or catalytic converters used for emissions control on internal combustion engines. Such catalysts may be, for example, activated carbon, or ceramic based, such as alumina or silicon carbide (SiC).

A current method of recovering precious metals, such as PGMs, for example platinum, from catalytic converters is by smelting (heating and melting) or burning. If instead, like the E-waste described above/herein, the precious metals are extracted by leaching, and thus leaving the ceramic substrate of the catalytic converter core relatively intact, the ceramic may be size reduced to provide a catalyst powder.

This powder is composed of mainly the mineral cordierite, or silicon carbide (SiC) and it would be an excellent substitute for at least part of the sand portion of a cement or mortar composite. As the cordierite or SiC powder may be finer than sand normally used for cement or mortar, the fine portion of the sand may be sifted out using a No. 40, 60, 70, 80, 100, or 120 sieve size, and then replaced with the cat powder should the direct substitution of the sand reduce strength/workability for the desired use. The surface of the mineral has been roughened from the leaching process, which allows for the physical ingress of cement or mortar within the pores enabling mechanical bonding which may lead to increased strength. Due to the spherical nature, it should not significantly affect workability even with porosity.

Substitution percentages of the cat powder may be from 5 wt % to 100 wt %, with or without sifting as dependent on the feed powder size and desired use. Should the adhesion of the cordierite within the cement be an issue, the following remedies are proposed: use within a polymer cement as opposed to ordinary Portland cement; and or surface treatment of the mineral with a coupling agent or base soak.

Cement based composite products whereby the catalyst powder may be incorporated into includes but is not limited concrete masonry units (CMUs)/cinder blocks, decorative cement formulations, structural cement formulations, mortars, low pH/limestone/magnesium cement formulations, vinyl or other concrete mixes, bitumen containing cement mixing such as asphalt, hydraulic/underwater applications for structural or decorative uses, in sand mix, with Portland or quick set cement mix, driveway/sidewalk repair formulations, and other paving applications. Applications of formulations may create products such but not limited to sidewalks/driveways, furniture, CMUs, curbs, flooring, fountains, statues, and patio bricks.

In an embodiment disclosed, E-waste powder and/or catalyst powder may be used as a polymer additive and/or in a cement based composite product.

### E-Waste General

In an embodiment disclosed, E-waste composites with the commodity plastics of HDPE, PP, and CoPP or other thermoplastics for the final product are provided. PP is a homopolymer, meaning its constituent monomers are all the same, whereas CoPP consists of more than one type of monomer. In an embodiment disclosed, internal batch mixing followed by compression molding may be used to compound the E-waste with the polymer, for example HDPE or PP composite materials or articles. In an embodiment disclosed, injection pressing/molding and/or compression pressing/molding may be used to obtain molded composite E-waste materials or articles, for example CoPP composite materials.

A reinforcing material or substrate may be provided to add additional strength, in particular tensile strength in at least one axis.

The binding agent may include an epoxy and/or resin. The binding agent may be a urea formaldehyde (UF) polymer, for example the type of resins used in medium-density fibreboard (MDF), or other thermoset polymer. The binding agent may be a methylene diphenyl diisocyanate (MDI) and/or a phenol formaldehyde (PF) combined with one or more additives for adhesion.

The composite article may include, for example, board panels, sheets, beams, planks, or deck boards, engineered beams, trusses or joists, consumer items such as furniture, e.g. a chair, building material, e.g. a brick or block, roof covering or roof shingle, road construction, e.g. aggregate or as a concrete substitute.

The composite article may be made using a manufacturing process. In an embodiment disclosed, the manufacturing process may include one or more continuous or multi-opening hot press.

In some embodiments disclosed, the manufacturing process works better with or requires blending the E-waste powder with a thermoplastic. Such processes may include injection molding and/or extrusion (without or with a polymer matrix) of the composite material in liquid or melted liquid form into a die and/or mold, or additive deposition, e.g. blended with thermoplastic and extruded into a usable filament for 3d printing.

In some embodiments disclosed, the manufacturing process includes blending the E-waste powder with hemp, a binder, and other adhesion promoting additives to provide an eco-friendly structurally reinforced plastic.

In some embodiments disclosed, the manufacturing process includes adding the E-waste powder to an insulating material (e.g. fiberglass, calcium silicate, expandable foam, polymer, filler and/or combinations thereof) during or after the manufacturing process of the insulation. The E-waste powder may be used as an insulation. The E-waste powder insulation or composite insulation may provide increased fire and/or flame resistance.

In some embodiments disclosed, the manufacturing process includes adding the E-waste powder to uncured concrete to improve the mechanical properties of the concrete, for example providing concrete that has increased strength and/or is less brittle and/or is more sound deadening for highways and vehicle traffic due to the plastic content. In some embodiments disclosed, the electronic waste plastic, ceramic, and fiber powder replaces or is combined with at least a portion of one or more conventional concrete ingredient as part of, or as the aggregate filler.

The following non-limiting example is illustrative of the present disclosure:

### Exemplary Embodiment of Plastic Forming

Referring to FIG. 6, in an exemplary embodiment, E-Waste may be processed to provide a final product by plastic forming.

Incoming E-Waste, for example including PCBs, wiring/connectors, is subject to a size reduction process. The size reduction process may include one or more shredding and/or milling steps. The resulting particles may have a size between about 100 microns to about 1000 microns after the size reduction process.

The particles may be subject to mechanical base metal reduction, for example, using one or more of magnetic field separation, eddy current separation, electrostatic separation, optical separation, gravity separation, sieving, and/or manual separation to remove one or more base metals such as iron, steel, and/or copper. One or more mechanical base metal stages may be used. The extracted solids are sent to base metal processing for further processing and/or recovery.

The particles, having a reduced base metal content, may be subjected to further base metal reduction by chemical base metal removal. One or more chemical liquids and/or powders may be added to form a slurry. The one or more chemical(s) leach at least a portion of one or more base metals into solution.

After a sufficient period of time, the slurry is subject to a liquid/solid separation process, and the liquid, containing base metal(s) in solution, is sent to base metal processing for further processing and/or recovery. One or more chemical base metal removal stages may be used.

The primarily solid portion remaining is then subject to a chemical precious metal leaching process, in which one or more chemical is added to leach one or more precious metal into solution.

While described above in two steps, with base metal processing and/or recovery followed by precious metal leaching, the order of operations may be modified. For example, base metal processing may instead follow precious metal leaching. In addition, while described above in two or more steps, base metal processing and precious metal leaching may instead be combined and occur in one chemistry step.

After a sufficient period of time, the slurry is subject to a liquid/solid separation process, and the liquid, containing precious metal(s) in solution, is sent to precious metal processing for further processing and/or recovery. One or more chemical precious metal leaching stages may be used.

An acid, for example HCl may be used to remove one or more CoC.

The primarily solid portion remaining is substantially plastic powder and is then subject to a plastic powder neutralization process. The plastic powder neutralization process may include pH adjustment.

The plastic powder is then subject to a plastic powder drying process to provide substantially dry plastic powder.

The plastic powder may be subject to one or more plastic powder pre-processing process. Such processes may include plasma treatment, or other surface treatment.

The plastic powder is subject to a powder adhesive coating process.

The plastic powder is then subject to a plastic powder mat forming process and a continuous and/or multi-opening hot press process, and the article is then cut to the desired size and/or shape to provide the final product.

The following non-limiting example is illustrative of the present disclosure:

### Exemplary Embodiment of Plastic Injection

Referring to FIG. 7, in an exemplary embodiment, E-Waste may be processed to provide a final product by plastic injection.

E-waste is processed similar to as in FIG. 6 through to providing dry plastic powder from a plastic powder drying process.

Then the plastic powder may be subject to a plastic powder sifting process.

The plastic powder sifting process may include sizing the particles and/or removing particles greater than a selected size and/or removing particles less than a selected size.

The plastic powder may be subject to one or more plastic powder pre-processing process. Such processes may include plasma treatment.

The plastic powder may be blended with a base pellet material in a plastic blending with base pellet material process.

The blend may be then injected into a mold in an inject material into mold process that could include high pressure and high temperatures, in order to provide the final product. The injected product could go through a tempering process of stress equalization at elevated temperatures, or tempered in a manner that involved rapidly cooling the plastic component.

### System

In a system aspect of the presently disclosed process, the e-waste may be disassembled, for example ECs separated from populated PCBs to provide a PCB stream and/or an EC stream. The E-waste is subject to size reduction, for example shredded and/or milling using one or more series of mechanical size reduction machines (e.g. pulverizer, hammer mill, attrition mill, ball mill, granulator, grinder, etc.) to provide E-waste particles.

The E-waste and/or electronic waste particles may be transported by conveyor, e.g. screw conveyor.

One or more mechanical separators are used to recover one or more metals (e.g. base metals and/or precious metals). The mechanical separators may include, for example, magnets, static charge (corona-roller separators), sieving and/or sifting.

One or more chemical separators are used to remove one or more metals (e.g. base metals and/or precious metals) and/or toxins and/or heavy metals, for example using one or more of a nitric acid process, a sulphuric acid process, an aqua regia process, a cyanide process, a processes disclosed in WO 2016/168930 “Methods for Simultaneous Leaching and Extraction of Precious Metals”, WO 2016/168933 “Methods for Selective Leaching and Extraction of Precious Metals in Organic Solvents”, PCT/CA2021/051102 titled “Methods for Leaching and Recovery of Platinum Group Metals in Organic Solvents” or combinations thereof.

The slurry is then conveyed (e.g. pumped or otherwise) into a liquids/solids separator, for example utilizing one or more centrifuge, dryer, filter, etc. to separate the slurry into a solids portion comprising the powder and a liquids portion comprising the leaching agent and leached material. The liquids portion may be subject to further processing to recover the base metals and/or precious metals as applicable, or maybe otherwise disposed of.

The powder is transported (e.g. by screw conveyor) to a next stage where the powder is used to create an article/material.

E-waste powder may be used as an additive for a composite plastic to form a composite article or composite material. The plastic may be, for example, a thermoplastic or a thermoset plastic. The thermoplastic may be, for example, polypropylene (PP), polypropylene copolymer (CoPP) or high density polyethylene (HDPE). The thermoset plastic may be, for example, urea formaldehyde (UF) or polyurethane (PU).

In an embodiment disclosed, the E-waste powder may be used in a medium density fiberboard (MDF) type process wherein a binding agent or agents and the powder are combined and a hot press used to form the article. The binding agent may, for example comprise urea formaldehyde (UF) or polyurethane (PU).

In an embodiment disclosed, the E-waste powder may be used in a “blending” type process wherein the powder is added to a base plastic as a concrete/asphalt. The E-waste powder may be used as an additive to a cement, mortar, or asphalt. In some embodiments disclosed, the electronic waste plastic, ceramic, and fiber powder replaces or is combined with at least a portion of one or more conventional asphalt ingredient. The following non-limiting example is illustrative of the present disclosure:

### Example

In an exemplary embodiment, incoming E-waste is pre-processed, for example by manual disassembly to remove large plastic and/or metal components such as cases, frames, bezels, brackets, etc. if present. However, in an embodiment disclosed, much of the E-Waste has already been disassembled such that it is ready for the size reduction step, since there is an existing ecosystem that presently recovers the “simple” components that contain value, and conveniently provides E-waste in a ready to process form, for example including PCBs and/or ICs.

### Step 1: Size Reduction Step

The initial E-waste feedstock may pass through a series of size reduction techniques to produce a powder in the order of 200-300 microns. This increases exposed surface area, and liberation of metals, fibers, and plastics, such that the leaching/chemistry steps can more effectively engage in reactions with the metals. A HVAC system may be equipped with dust suppression systems, and a chemical scrubber that neutralizes any off gassing, if such was to occur.

### Step 2: Base Metal Recovery Step

E-waste powder produced from Step 1 is passed through a series of refining methods. As described above a first step may be a sulfuric acid (H₂SO₄) leach, in order to remove one or more base metal and/or heavy metal. In an embodiment disclosed chemical treatment and/or leaching may be used to remove several base metals, and in an embodiment disclosed many or up to all of the 59 base metals present in E-waste may be removed.

The leaching step also removes harmful metals such as lead, mercury, arsenic, etc. that are not desired in the final plastic product. The metals are leached into a solution then separated from the plastic-fiber-precious metal aggregate powder. In an embodiment disclosed separation may be via a centrifuge. The base metals may then be precipitated from solution as an impure mixture of metals or may be selectively recovered or a combination thereof.

### Step 3: Precious Metal Recovery Step

In this step, precious metal (e.g. gold) containing E-waste powder may be processed in a leaching step where the precious metal is leached from the E-waste powder. Next, a gravity-enhanced separation step may be performed to separate gold containing liquid from the E-waste powder. As described above, there are a number of suitable chemical leaching agents and precipitants that may be used with the presently disclosed technology. The gold is recovered from that step and the remaining E-waste powder is then neutralized and rinsed to remove leaching chemicals, and is substantially plastics and fibers.

The order of step 2: base metal recovery step and step 3: precious metal recovery step may be reversed, with precious metal recovery instead occurring before base metal recovery, or the steps may be combined into a single combined base and precious metal recovery step.

### Step 4: Flame Retardant Removal

As described previously, after the metals are removed, the E-waste particles are then subjected to a hydrochloric acid (HCl) leach to remove lead, remaining base metals, and remaining chemicals of concern (CoC).

### Step 5: Plastics Recovery and Shaping Step

Once the above steps are accomplished, the recycling of the plastics and fibers is achievable. Raw plastic powder may be mixed with a casting adhesive to generate inexpensive, safe, and environmentally friendly construction materials for eco-conscious “upcycling”.

### Examples

The E-waste powder provided by the present disclosure may be used in many ways, for example but not limited to, as an additive for a composite plastic to form a composite article or composite material. The plastic may be, for example, a thermoplastic or a thermoset polymer. The thermoplastic may be, for example, polypropylene (PP), polypropylene copolymer (CoPP) or high density polyethylene (HDPE). The thermoset polymer may be, for example, urea formaldehyde (UF) or polyurethane (PU).

The following non-limiting examples are illustrative of the present disclosure:

### Example 1—Injection Molded E-Waste Reinforced Copolymer Polypropylene (CoPP) Composites

### Materials and Methods

E-waste powder from IC chips removed from PCBs, processed as described herein above. Various E-waste reinforced CoPP composites were produced with different E-waste powder concentrations, of 10 wt %, 20 wt %, 30 wt %, 40 wt %, 50 wt % and 60 wt % using a one step process injection molding press 110T Roboshot.

ASTM D638 Type I dog bone sample specimens with a thickness of 3 mm were created to test tensile and hardness properties, and the composite parts were tested using a tensile testing machine, and a durometer Shore D.

The total material used to process each batch was 1 kg of CoPP and ICCP for a total of 7 batches: Batch A: 100% CoPP (Neat CoPP); Batch B: 90% CoPP+10% ICCP; Batch C: 80% CoPP+20% ICCP; Batch D: 70% CoPP+30% ICCP; Batch E: 60% CoPP+40% ICCP; Batch F: 50% CoPP+50% ICCP; and Batch G: 40% CoPP+60% ICCP.

To create the Type I dog bone specimens, the following procedure was followed: a magnet was placed in the hopper to catch any potential magnetic metal particles remaining in the ICCP. To set processing conditions, neat CoPP was used as a baseline for the injection parameters. At least 20 test dog bones of pure CoPP were produced. Before and after each batch, the hopper of the press was cleaned. Starting with the smallest amount of ICCP (10 wt %), canola oil was added and mixed to aid in binding the CoPP and ICCP together at different blend ratios. The injection press was operated until 20 good test bones were prepared.

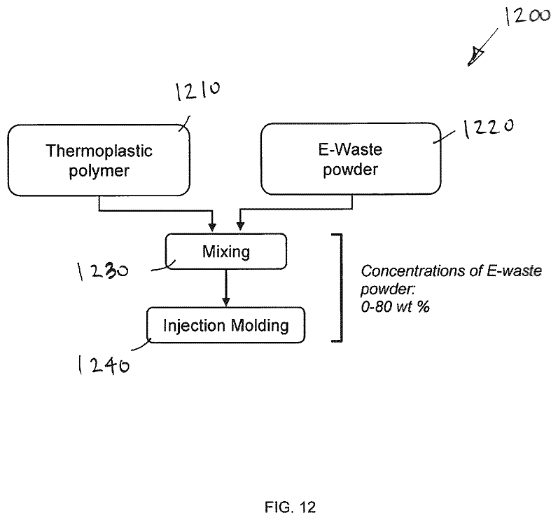

Referring to FIG. 12, a schematic for an E-waste reinforced CoPP injection molding process is shown. In an example process 1200, thermoplastic polymer 1210 and E-waste powder 1220 are mixed 1230 and then subjected to injection molding 1240.

Copolymer polypropylene (CoPP) and E-waste powder is mixed, injection molded, and the resulting article subjected to mechanical testing. In this case the E-waste powder is ICCP, and concentrations of 0, 10, 20, 30, 40, 50 and 60 wt % were considered

The processing conditions of CoPP injection molding is shown below in Table 2 below.

TABLE 2

| TEST | A | B | C | D | E | F | H | |
|---|---|---|---|---|---|---|---|---|
| MIXTURE | 100% | 90% | 80% | 70% | 60% | 50% | 40% | UNIT |
| | COPP | COPP | COPP | COPP | COPP | COPP | COPP | |
| CANOLA OIL | 0 | 1 | 1.5 | 2 | 4 | 5 | 3 | tsp |
| NOZZLE TEMP. | 470 | 458 | 485 | 485 | 485 | 485 | 485 | ° F. |
| FRONT TEMP. | 460 | 460 | 460 | 460 | 460 | 460 | 460 | ° F. |
| CENTER TEMP. | 440 | 440 | 440 | 440 | 440 | 440 | 440 | ° F. |
| REAR TEMP. | 410 | 410 | 410 | 410 | 410 | 410 | 410 | ° F. |
| THROAT TEMP. | 120 | 120 | 120 | 120 | 120 | 120 | 120 | ° F. |
| SHOT WEIGHT | 13.6 | 13.9 | 14.5 | 15.2 | 15.9 | 16.8 | 18.2 | g |
| CYCLE TIME | 38.3 | 38.4 | 38.4 | 43 | 43 | 40.3 | 46.9 | sec. |
| FILL TIME | 1.422 | 1.473 | 1.473 | 1.473 | 1.473 | 1.473 | 1.362 | sec. |
| COOL TIME | 25 | 25 | 25 | 25 | 25 | 25 | 25 | sec. |
| A MOLD TEMP. | Tower | Tower | Tower | Tower | Tower | Tower | Tower | ° F. |
| | 80 | 80 | 80 | 80 | 80 | 80 | 80 | |
| B MOLD TEMP | Chiller | Chiller | Chiller | Chiller | Chiller | Chiller | Chiller | ° F. |
| | 60 | 60 | 60 | 60 | 60 | 60 | 60 | |
| SHOT SIZE | 1.5 | 1.5 | 1.5 | 1.5 | 1.5 | 1.5 | 1.5 | in. |
| CUSHION | 0.328 | 0.417 | 0.354 | 0.337 | 0.366 | 0.371 | 0.417 | in. |
| INJECTION SPEED 1 | 1.00 | 1.00 | 1.00 | 1.00 | 1.00 | 1.00 | 1.20 | in/sec |
| INJECTION SPEED 2 | 0.90 | 0.90 | 0.90 | 0.90 | 0.90 | 0.90 | 1.10 | in/sec |
| INJECTION SPEED 3 | 0.60 | 0.60 | 0.60 | 0.60 | 0.60 | 0.60 | 0.80 | in/sec |
| INJECTION PRESSURE | 5420 | 4912 | 5594 | 6000 | 5935 | 4341 | 10087 | psi |
| MAX. PRESSURE | 8500 | 8500 | 5594 | 8500 | 8500 | 8500 | 10000 | psi |
| HOLD PRESSURE 1 | 3000 | 3000 | 4000 | 4000 | 4000 | 4000 | 5000 | psi |
| HOLD PRESSURE 2 | 2500 | 2500 | 3500 | 3500 | 3500 | 3500 | 4000 | |
| HOLD TIME 1 | 2 | 2 | 2 | 2 | 2 | 2 | 4 | sec. |
| HOLD TIME 2 | 2 | 2 | 2 | 2 | 2 | 2 | 4 | |
| SCREW SPEED | 125 | 90 | 100 | 100 | 100 | 85 | 85 | rpm |
| BACK PRESSURE | 850 | 850 | 850 | 850 | 850 | 850 | 850 | psi |

### Results and Discussion

Mechanical properties of CoPP composites were tested by using a Durometer Shore D scale and an Instron Tensile Machine to obtain hardness and tensile strength properties.

The hardness of the neat and CoPP composites at different ICCP concentrations (0 to 60 wt %) are shown in Table 3 below. Incorporation of different ICCP concentrations from 10 wt % to 60 wt % produced an increase of up to 10% in the hardness of the material. This is correlated to the increase of volume fraction of rigid particles in the soft polymeric phase.

The hardness Shore D of CoPP composites (3.1 mm sample thickness) is shown below in Table 3.

TABLE 3

| | Hardness |
|---|---|
| E-waste Content | 3.1 mm sample thickness |
| (wt. %) | (Shore D) |

| | | |
|---|---|---|
| 0 | wt. % | 56.4 |
| 10 | wt. % | 56.8 |
| 20 | wt. % | 57.5 |
| 30 | wt. % | 57.9 |
| 40 | wt. % | 58.7 |
| 50 | wt. % | 59.5 |
| 60 | wt. % | 61.8 |

(10% increase)

The tensile strength of CoPP composites was tested and results are shown in Table 4 below. It is observed that the strength of the composites was progressively decreased when incorporating up to 60 wt % ICCP into CoPP. As described elsewhere herein, surface treatment of the E-waste powder may improve dispersibility and interfacial adhesion or wettability of nanoparticles.

Tensile data for CoPP composites is shown below in Table 4.

TABLE 4

| | | | | Tensile Strength | | Fracture |
|---|---|---|---|---|---|---|
| | Test | Width | Thickness | [Ultimate] | Elongation | Mode |
| Sample | ID | (in) | (in) | (psi) | [at fracture] | (Brittle or |
| (#) | (#) | [mm] | [mm] | [MPa] | (%) | Ductile) |
| Neat | 1 | 0.495 | 0.107 | 3.014 | na | Ductile |
| 100 CoPP | | 12.56 | 2.71 | 20.8 | | |
| 10 wt % | 2 | 0.493 | 0.112 | 2.883 | 12.9 | Brittle |
| RCP/90 CoPP | | 12.52 | 2.84 | 19.9 | | |
| 20 wt % | 3 | 0.494 | 0.115 | 2.546 | 6.5 | Brittle |
| RCP/80 CoPP | | 12.54 | 2.92 | 17.6 | | |
| 30 wt % | 4 | 0.493 | 0.119 | 2.297 | 4.9 | Brittle |
| RCP/70 CoPP | | 12.53 | 3.02 | 13.8 | | |
| 40 wt % | 5 | 0.494 | 0.118 | 2.280 | 4.1 | Brittle |
| RCP/60 CoPP | | 12.54 | 2.99 | 15.7 | | |
| 50 wt % | 6 | 0.494 | 0.117 | 2.095 | 3.2 | Brittle |
| RCP/50 CoPP | | 12.55 | 0.15 | 14.4 | | |
| 60 wt % | 7 | 0.496 | 0.122 | 1.622 | 2.4 | Brittle |
| RCP/40 CoPP | | 12.60 | 3.10 | 11.2 | | |

The tensile strength (MPa) for a 3 mm sample thickness of CoPP composites is shown below in Table 5.

TABLE 5

| | Tensile Strength |
|---|---|
| | 3 mm Sample thickness |
| E-waste Content | (MPa) |

| | | |
|---|---|---|
| 0 | wt. % | 20.8 |
| 10 | wt. % | 19.9 |
| 20 | wt. % | 17.6 |
| 30 | wt. % | 15.8 |
| 40 | wt. % | 15.7 |
| 50 | wt. % | 14.4 |
| 60 | wt. % | 11.2 |

Various blend ratios of neat CoPP and ICCP were produced to create E-waste reinforced CoPP composites. Each test gradually increased the part weight as more ICCP was added. The nozzle temperature was raised from baseline. A high ratio of ICCP versus neat CoPP reduces the flexibility of the plastic and increased the brittleness. The material was harder to push through the barrel and stuck more to the mold. Addition of different ICCP concentrations from 10 wt % to 60 wt % into CoPP increased the hardness of the material but decreased the tensile strength. Large formation of agglomerates was observed in the fractured surface of CoPP composites.

The masterbatch technique is widely used in industry to improve dispersibility of nanoparticles. A masterbatch is a highly concentrated mixture of an additive with a carrier polymer which then is diluted into another polymer to produce the final composite. In an embodiment disclosed, an extruder may be used to obtain an optimum and homogenous dispersion of E-waste particles in the production of the masterbatch pellets.

### Example 2—Medium Density Fibreboard (MDF) and/or Thermosetting Manufacturing

### Materials and Methods

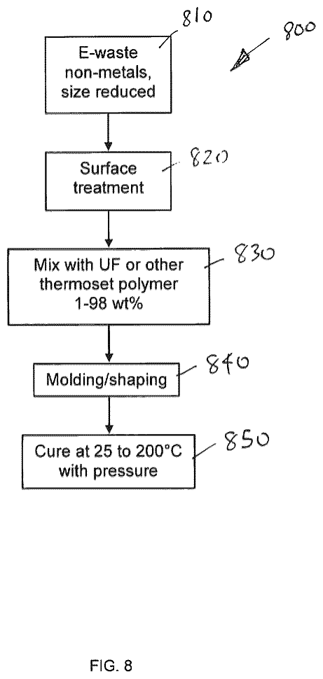

Referring to FIG. 8, the E-waste after metal leaching to remove at least a portion of base metals and precious metals was passed through a ball-mill to provide a powder of generally uniform size and shape, with a particle size between about 100 nm and 250 microns. In an example process 800 of FIG. 8, size reduced non-metal E-waste 810 is treated with a surface treatment 820 and then mixed 830 with UF or other thermoset polymer, for example, at about 1-98%, and then molded/shaped 840 and cured 850, for example at about 25-200° C. with pressure.

The E-waste powder was surface treated by reacting with a coupling agent to introduce an adequate number of functional groups on the particles to react/interact with Urea Formaldehyde (UF) polymer.

To prepare the binder, the UF resin was mixed with water according to the instructions of the manufacturer. The mixture was then stirred to a homogeneous blend before the addition of the E-waste powder to obtain 50 wt % final composition.

The mixture was stirred for a few minutes, until the E-waste particles were substantially dispersed within the polymer and a substantially homogeneous suspension was obtained.

The highly viscous mixture was poured into an aluminum mold. The mold was closed after filling and pressed by clamps before placing in an oven set at 50° C. for two hours to cure.

After two hours, the curing is complete, the mold is opened, and the E-waste Medium Density Fibreboard (MDF) resin is released.

The same procedure but with no powder was used to prepare neat UF parts for comparison of hardness.

### Results and Discussion

The hardness shore D of neat UF was 72.83 and for 50 wt % E-waste improved to 79.83. The measured density of neat polymer and composite was 1.137 g/ml and 1.537 g/ml, respectively.

The density of the MDF composite is higher than wood fibre MDF.

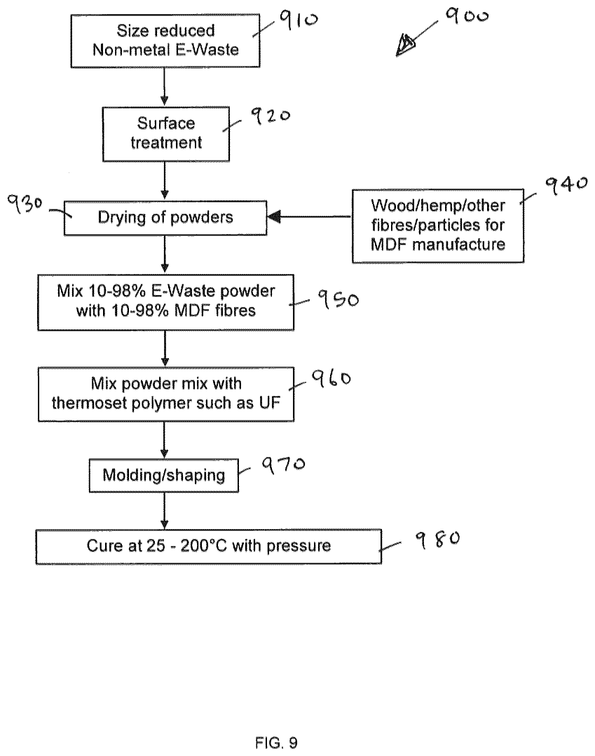

In some embodiments, referring to FIG. 9, the MDF composite may be filled with a combination of E-waste and other fillers (one or more of wood, hemp, glass, or other fibers/particles). The composition may have a large range, for example 10-90% E-waste, 10-90% wood, and any combination in-between. In an example process 900 of FIG. 9, sized reduced non-metal E-waste 910 is treated with surface treatment 920 and the powders dried 930. Wood/hemp/other fibres/particles for MDF manufacture 940 are added, for example mix 10-98% E-waste powder with 10-98% MDF fibres 950. Then the powder mix is mixed 960 with thermoset polymer such as UF, and then molded/shaped 970 and cured 980, for example at about 25-200° C. with pressure.

Brominated flame retardant (BFR) that remains in the e-waste after chemical processing are bonded to the e-waste “backbone” and do not pose a health risk, and may provide some fire resistance to the end product.

An alternative adhesive to urea-formaldehyde (UF) may be used. In some embodiments, adhesives used for wood fibre MDF may be used for e-waste particle MDF composites. In some embodiments, Phenol-Formaldehyde (PF), Methylene diphenyl diisocyanate (MDI), or soy-based glue may be used.

However, using e-waste instead of wood may enable the use of different adhesives, not currently suitable for wood fibres, but sufficient for e-waste particles, which may be better for the environment than the alternatives currently used in wood fibre MDF industry.

In some embodiments, a MDF manufacturing process used for wood fibre may be adapted to provide a MDF manufacturing process using E-waste. An exemplary MDF manufacturing process used for wood fibre may include stages¹³: 1. Debarker/chipper/screen; 2. Chip washer; 3. Defibrator (where resin and dispersant are also added); 4. Dryer/sifter; 5. Mat former/precompressor/continuous press/saws/storage; and 6. Cut to final size/dicing. As of the filing date of this application, a diagram of an exemplary MDF manufacturing process is available at: https://www.researchgate.net/figure/MDF-manufacturing-process-wood-force-plant_fig1_312259282. If adapting standard MDF production equipment, stages 1, 2 and 3 could be skipped for an MDF manufacturing process using E-waste.

The particle distribution is more uniform and consistent with e-waste particles than wood fibers, which allows for a more consistent end-product (size, material properties, etc).

In some embodiments, a thermoplastic base material with a portion of E-waste filler and additional filler material may be used. The additional filler may be, for example, wood pulp, hemp, glass, etc.

The end-use products may be, for example, wood alternative MDF panels or boards, for example composite decking boards using recycled plastics, such as those made by Trex™.

### Example 3—Cement Products

### Materials and Methods

Sand is the world's second most consumed natural resource after water, and the world is facing a shortage owing to the extensive use of concrete worldwide. The type of sand necessary for construction projects cannot be found on a beach, as this sand is smooth due to weathering phenomena, and therefore is not ideal for imparting flexural strength within the cement matrix¹⁴. Through the presently disclosed chemical treatment process, the main component left behind is composed of silica (sand), as indicated by FTIR analysis, in addition to epoxy and fiberglass. Addition of fibrous materials is known to improve the toughness of cementitious materials due to the fibre bridging ahead of a forming crack. This fibre bridging is one of the reasons why the PCB fraction is enticing in cement, as well as the proportion of silica present in this E-waste¹⁵.

### Results and Discussion

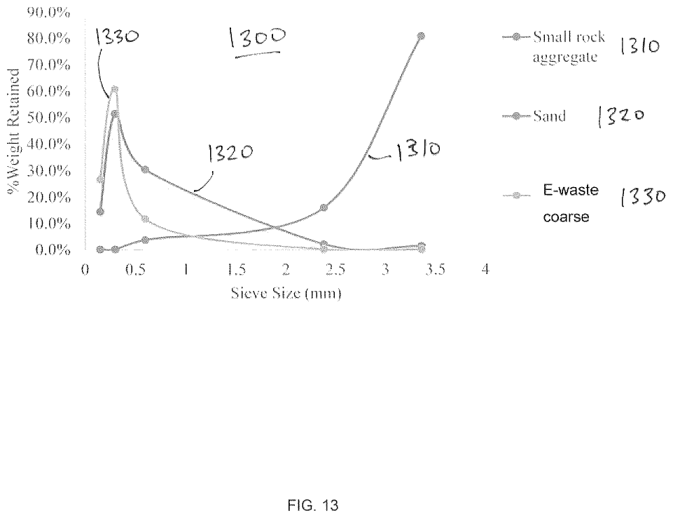

Grading is the term for determining the particle size distribution of the concrete aggregates. The size distribution of sand is similar to the size distribution of ICCP coarse fraction (>250 μm), as shown in FIG. 13. In an example grading 1300, the distribution of small rock aggregate 1310, sand 1320, and E-waste coarse 1330 are shown.

With the mixing tests performed, it was found that some mortar and concrete cubes present bleeding, which refers to the seeping of excess water to the surface of the concrete when there is more water present than needed to hydrate cement resulting in a decrease in strength. Due to this occurrence happening at the common 0.5 water/cement (w/c) ratio, this means that less water can be used, which is a significant advantage in industry.

The compressive strength results shown in Table 6 below show the difference between the neat mortar cube sample and 10-20 wt % replacement with E-waste. The >60 refers to a 60 mesh screen to ensure appropriate size for chemical treatment, which translates to 250 microns. Full HDs refers to PCBs populated with ICs whereas PCBs refers to depopulated PCBs and RAM refers to ICs (e.g. random access memory (RAM) ICs). Concrete and cement-based composites continuously harden over time therefore strength was measured at the same daily interval after making the sample.

TABLE 6

| Testing | Mix Ratio | | | | | |
|---|---|---|---|---|---|---|
| Interval | (cement:sand: | | E-Waste | E-Waste | Strength | % change |
| (Days) | aggregate) | w/c | Replacement | Type | (MPa) | compared to Neat |
| 7 | 1:1:1 | 0.5 | 0 | | 25.8 | |
| 7 | 1:0.85:0.85 | 0.5 | 15% | PCBs > 60 | 21.1 | −18% |
| 7 | 1:0.85:0.85 | 0.5 | 15% | Full | 23.9 | −7% |
| | | | | HDs > 60 | | |
| 7 | 1:2:0 | 0.46 | 0 | | 31.8 | |
| 7 | 1:1.81:0 | 0.43 | 10 | RAM > 60 | 30.5 | −4% |
| 7 | 1:1.61.0 | 0.46 | 20 | RAM > 60 | 29.2 | −8% |

The specimens tested had a mortar mix of one part cement, two parts sand, and 0.5 w/c, as well as a concrete mix of one part cement, one part sand, one part aggregate, and 0.45 w/c. The mortar tests were used to reduce the significant strength gained from large aggregates on the overall strength of the mixture, and to ensure that the effect of the E-waste replacement of sand was more pronounced. These tests show that the strength can remain substantially unaffected with the addition of E-waste into the cement matrix.

The strength values indicate that with 10% replacement of coarse fraction E-waste, the strength change is negligible and falls within the expected margin of error in testing. Surface adhesion and the bonding of the E-waste to the cement paste matrix is the most important factor for improvement of cement based composite properties, as seen from the failure mechanisms in compression tests in literature.

A coupling agent may be used to treat the powder such that the cement components may react with and form a chemical bond with the E-waste. Treatments for the surface may be, but are not limited to, a single or combination of agents listed:
1. A silane coupling agent:
a. 3-methacryloxypropyltrimethoxysilane (KH570);
b. 1-Methoxy-2-propanol acetate+polyether (BYK-C 8000); and/or
c. γ-aminopropyltriethoxy silane.
2. Carboxylated styrene-butadiene rubber (CSBR) latex.
3. Sodium hydroxide soaking surface treatment.

### Example 4—Polyurethane (PU) End Product

### Materials and Methods

A polyurethane formulation produced has an initial durometer of 60 Shore A. Neat PU and PU composites with different concentration of E-waste powder were produced for comparison purpose. The aim was to target a final hardness of 85 Shore A in the final product, as it is the most common specification used at various polyurethane manufacturing facilities. It is known from previous experimental work that after addition of rigid nanoparticles into polyurethane elastomers, the gelation time (pot-life) decreases, and the hardness increases by 20-30%; for this reason, a PU formulation with low hardness scale was chosen to reach a final hardness of 80-85 shore D for the final product.

The mass percentages for production of E-Waste reinforced polyurethane (PU) composites is shown below in Table 7.

TABLE 7

| | | Batch #2 | Batch #3 | Batch #4 |
|---|---|---|---|---|
| | Batch #1 | 5/95 PU 60 | 10/90 PU 60 | 20/80 PU 60 |
| | Neat PU 60 | Shore A | Shore A | Shore A |
| Material | Shore A (wt %) | (wt %) | (wt %) | (wt %) |
| E-waste | 0 | 5 | 10 | 20 |
| Polyol | 78.1 | 78.1 | 78.1 | 78.1 |
| Crosslinker | 2.97 | 2.97 | 2.97 | 2.97 |
| MDI | 18.21 | 18.21 | 18.21 | 18.21 |
| Silicon Oil | 0.62 | 0.62 | 0.62 | 0.62 |
| Moisture | 0.02 of total | 0.02 of total | 0.02 of total | 0.02 of total |
| Scavenger | polyol | polyol | polyol | polyol |

Extra care was taken to ensure adequate mixing and dispersion of E-waste within the PU to obtain desired properties. Production of microbubbles (trapped air within the sample) significantly decreases the final mechanical properties of the PU.

To obtain the sample specimens, a sample press cutter was used to cut PU samples of 16 mm diameter +/−0.2 mm from a flexible test plate/sheet with 12.5 mm thickness +/−0.2 mm using a manual sample cutter press.

After fabrication of E-waste/polyurethane composites, mechanical testing was performed on the samples to collect hardness and wear resistance data.

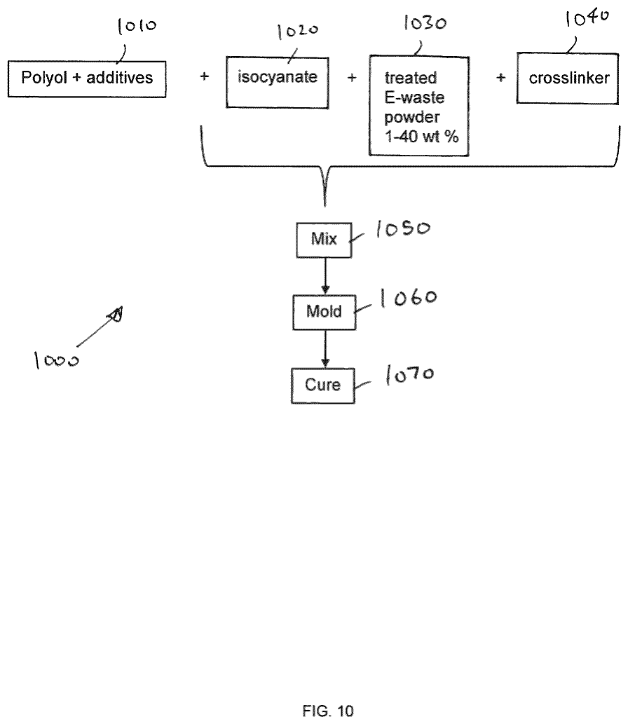

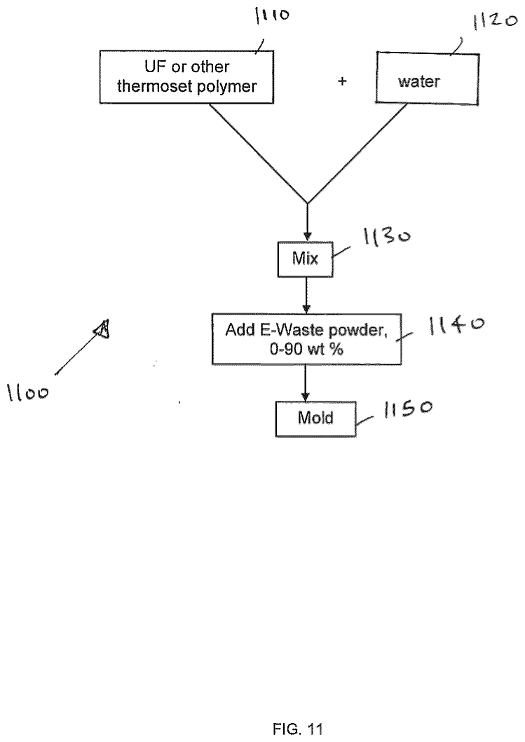

Referring generally to FIG. 10, in an example process 1000, polyol plus additives 1010 are combined with isocyanate 1020 treated E-waste powder 1030, for example in an amount of 1-40 wt %, with crosslinker 1040, and then mixed 1050, molded 1060 and cured 1070 to produce E-waste reinforced polyurethane (PU) composites at different filler concentrations. In an embodiment disclosed, an example process includes:

Polyol, crosslinker and isocyanate are melted at 90° C.

Degassing process should be done on polyol for 30 min.

While degassing the polyol. Set the temperature-controlled oven at 125° C.

Spray release agent over the steel mold before pre-heating the mold, and pre-heat the steel mold where the PU product will be cured at 125° C. for 2 hours.

Calculate the amount of chemicals required for a formulation of 60 Shore A durometer (see Table 8 below).

Weigh Polyol, silicon oil and moisture scavenger and mix it all together to form a “Part A” pre-mixture. Hand mix Part A very slowly to avoid production of microbubbles.

Prepare the crosslinker and let it rest in the oven at 90° C. to form a “Part B” pre-mixture.

Prepare isocyanate and mix it with the E-waste powder to form a Part C pre-mixture. Hand mix for 5 minutes part C pre-mixture.

Mix Part A, part B and part C at the same time for 45 seconds, with order of addition should be Part C into Part A, and Part B into Part A).

Use a urethane with a pot life/gelation time above 5 mins, as the E-waste additive will greatly reduce this time once it is added.

At about 45 seconds the polyurethane reaction is observed to be starting the crosslinking process to reach pot-life.

Slowly dispense the polyurethane in the hot steel mold to avoid production of microbubbles.

Cure the sample for 1 hour in the oven at 125° C.

Post-cure the sample at ambient temperature overnight.

The sample press cutter was used to obtain the abrasion resistance samples with 12.5 mm thickness and 16 mm diameter.

Final mechanical properties testing should be done ideally after day number 7 of PU preparation. However, in this example, results were obtained after day number 3.

A steel mold with a mobile metal bar, that can be fixed at different thicknesses, was used to provide good compression of the material, and produce the testing plates/sheets at 12.5 mm.

The processing conditions are shown below in Table 8 below.

TABLE 8
Processing conditions

| | Temperature (° C.) | Time | |
|---|---|---|---|
| Pre-heating Mold | 125 | 2 | hours |
| Melting of raw materials | 90 | 30 | min |
| Part A mixing | 85 +/− 5 | 2 | min |
| Part B mixing | 65 +/− 5 | 2 | min |
| Part C mixing | 55 +/− 5 | 5 | min |
| Part A, B and C mixing | 80 +/− 5 | 45 | seconds |

| | | |
|---|---|---|
| Molding and Curing | 125 | 60 |
| Post- curing | Room temperature | 3 days (optimum 7 |
| | | to 15 days). |

### Results and Discussion

Hardness of polyurethane composites was tested using a durometer Shore A scale. The hardness shore A of polyurethane composites at different E-waste powder concentrations are shown below in Table 9 below. Incorporation of 20 wt % E-waste powder in polyurethane resulted in a 61.6% increase in the hardness of the material.

TABLE 9

| | Hardness Shore A of E-waste |
|---|---|
| | reinforced Polyurethane |
| | Composites |
| Neat PU - Durometer 60A | 59.9 |
| 5 wt % E-waste/95 wt % PU | 60.0 |
| 10 wt % E-waste/90 wt % PU | 94.2 |
| 20 wt % E-waste/80 wt % PU | 96.8 |

Density of the polyurethane was also calculated following the Archimedes principle (i.e., volume displacement principle). It is observed that as expected in this test, increasing E-waste concentration on polyurethane composites, increased the density of the material by 13.2%.

The density of PU composites (g/cm³) is shown below in Table 10.

TABLE 10

| | Density of Polyurethane |
|---|---|
| | composites |
| | (g/cm³) |
| Neat PU | 1.06 |
| 5 wt % E-waste/95 wt % PU | 1.18 |
| 10 wt % E-waste/90 wt % PU | 1.20 |
| 20 wt % E-waste/80 wt % PU | 1.20 |

Abrasion rate was tested three times for each batch using the abrasion rotating drum machine. Table 11 shows the resulting abrasion for the polyurethane composites at different E-waste concentration. The sample disk with 12.5 mm diameter provided a flat surface which facilitated the accurate testing of the material.

The abrasion of PU composites (mm³) is shown below in Table 11.

TABLE 11

| | Abrasion of Polyurethane |
|---|---|
| | composites |
| | (mm³) |
| Neat PU | 38.47 |
| 5 wt % E-waste/95 wt % PU | 75.20 |
| 10 wt % E-waste/90 wt % PU | 134.14 |
| 20 wt % E-waste/80 wt % PU | 1528.80 |

Polyurethane composites were successfully produced at different e-waste powder concentrations (i.e., 5 wt %, 10 wt % and 20 wt %). Hardness of the material was observed to increase 61.6% when compared with virgin polyurethane. Moreover, density of polyurethane composites slightly increased after continuous addition of E-waste powder.

Addition of reaction retardant can be added to the formulation to decrease gelation time in the polyurethane reaction and achieve longer mixing times.

### Example 5—E-Waste Reinforced Urea Formaldehyde (UF) Composites at Different IC Chip Powder (ICCP) Concentrations

### Materials and Method

E-waste (IC Chip powder-ICCP) reinforced Urea Formaldehyde (UF) composites with different ICCP concentrations were produced at wt % and 50 wt %. Moulded samples with a thickness of 6 mm were created to test hardness properties. The composite parts were tested using a durometer Shore D.

The total material used to process each batch was 32 grams to produce a total of 2 batches. The first batch was made only with UF/water mixture (i.e., 16 grams of UF/water mixture) to produce the neat UF composite. The second batch was produced by mixing 16 grams of ICCP with 16 grams of UF/water mixture: batch #1: 100 wt % UF (Neat UF); and batch #2: 50% wt % UF+50% ICCP.

Referring to FIG. 11 and below, in an example process 1100, urea formaldehyde (UF) or other thermoset polymer 1110 and water 1120 are mixed 1130, and E-waste powder in an amount of, for example, 1-90 wt % added 1140, and then applied to mold 1150.

In an embodiment disclosed, an example process includes:
1. Surfaces should be clean, dry, smooth, and free from all foreign material.
2. Water temperature must be between 68° F. (20° C.) and 100° F. (38° C.). Water at ambient temperature was used (22° C.).
3. Measure UF powder and water into separate containers. Use a ratio of 10 to 6 parts (UF powder to water ratio)
4. Add powder slowly to the water while mixing continuously until uniform mix is achieved. Final consistency should be a smooth, creamy paste.
5. Filler mixing directions: after 15 minutes of manually mixing the UF powder and water, add 50 wt % of ICCP E-waste powder into the UF/water mixture.
6. Manually mix the UF/Water/ICCP mixture for 10 minutes.
7. Place the mixture in the mold and compress it to release trapped air bubbles.
8. Cure the mixture at 49-50° C. for 2 hours.
9. Full bond strength and moisture resistance develops after curing at room temperature for 7 days.

The processing conditions are shown below in Table 12.

TABLE 12
Processing Conditions and Properties

| UF resin to Water ratio | 10 to 6 parts | |
|---|---|---|
| UF resin ideal mixing temperature | 25° | C. |
| Curing temperature | 49-50° | C. |
| Mixture pot-life | 4-5 hours @21° C. | |
| Curing time | 2 hours at 49-50° C. | |
| UF/ICCP mixture pot-life | 1-3 | min |
| Viscosity | 1200-3000 | cP |

### Results and Discussion

Hardness is a measure of the resistance of a material to the penetration of a needle under a defined spring force. Hardness scale A and D values ranges from 0 to 100. Scale A is used to test soft/flexible materials, while scale D for rigid/hard types. Hardness of UF/ICCP composites was tested by using a Durometer Shore D scale. At least 5 measurements were performed at ambient temperature and the hardness average values for the neat UF and 50 wt % ICCP filled composites are shown in Table 3. Incorporation of 50 wt % ICCP produced an increase of up to 14.4% in the hardness of the material. This is correlated to the increase of volume fraction of rigid particles in the soft polymeric phase. The hardness Shore D of UF/ICCP composites is shown below in Table 13.

TABLE 13

| | Hardness Shore D |
|---|---|
| | Urea Formaldehyde Composites |
| Neat UF | 70.3 |
| 50/50 UF/ICCP wt % | 80.4 |
| | (14.4% increase) |

Although the presence of microbubbles was observed, hardness of the UF composite was not significantly affected. However, a scavenger could be used to extract the moisture and avoid bubbles trapped in the matrix. Air bubbles can decrease the interfacial adhesion between the E-waste particles and the polymer phase. Moreover, a higher shear rate mixer is required along with silane treatment of the E-waste powder to improve dispersibility and wettability of nanoparticles.

Neat UF and 50 wt % ICCP were produced to compare properties between neat UF and E-waste reinforced UF composites. Microbubbles were observed for both neat UF and 50 wt % filled ICCP/UF composites. It is recommended to use a moisture scavenger that is compatible with UF resin, as well as a compression moulding machine to extract the trapped air and moisture in the sample. Hardness shore D was tested for both neat and filled UF composites. Addition of 50 wt % ICCP concentration increased hardness of the material by 14.4%.

One can conclude that incorporation of E-waste powder resulted in the reinforcement of the polymer matrix.

### Example 6—E-Waste Reinforced Urea Formaldehyde (UF) Composites at Different PCB and IC Chip Powder (ICCP) Concentrations

### Materials and Method

In order to compare the properties between commercial grade MDF, melamine coated board, and E-waste based UF composites, hardness testing, water absorption and swelling testing was conducted. The E-waste based UF composites were prepared as above, and the following compositions tested:
Batch sample #1: Commercial grade MDF
Batch sample #2: Commercial grade melamine coated MDF
Batch sample #3: Neat urea formaldehyde (No E-waste fillers added)
Batch sample #4:50 wt % UF+50 wt % untreated IC Chip powder
Batch sample #5:60 wt % UF+40 wt % untreated PCB powder
Batch sample #6:60 wt % UF+40 wt % surface treated PCB powder
Batch sample #7:50 wt % UF+50 wt % untreated PCB powder

### Results and Discussion

A comparison of the properties between commercial grade MDF and E-waste based UF composite was conducted in this study and are shown in Tables 14 below. Particularly, the effect of E-waste powder (i.e., IC chip and PCB powder) on the surface hardness of MDF is analyzed.

TABLE 14

| | Hardness Shore D of Commercial |
|---|---|
| | MDF versus IC Chip Powder/UF |
| Batch | composites |
| Commercial MDF | 77.4 |
| Commercial Melamine coated | 74.8 |
| board | |
| Neat UF | 73.6 |
| 50 wt % IC Chip powder | 79.8 |

Results of the hardness tests showed significant difference in the hardness values measured in the different materials. For instance, IC chips/UF composite shows a higher hardness value (i.e., 7% increase when incorporating 50 wt % IC Chip powder) compared with commercial grade melamine coated MDF. This improvement in hardness resulted in superior screw-holding properties for the IC Chip/UF composite compared to both commercial grade MDF and melamine coated MDF.

Table 15 below shows the hardness average values for two types of commercial grade MDF and PCB powder UF composites. There was no degradation in properties by replacing 40 wt % to 50 wt % of UF resin with PCB powder. In addition, screw holding strength was also improved in PCB/UF composites when compared to neat MDF boards (no filler added).

TABLE 15

| | Hardness Shore D of Commercial |
|---|---|
| | MDF versus PCB powder/UF |
| Batch | composites |
| Commercial MDF | 77.4 |
| Commercial Melamine coated | 74.8 |
| board | |
| Neat UF | 73.6 |
| Untreated 40 wt % PCB/60 wt % UF | 62.6 |
| Silane Treated | 74.4 |
| 40 wt % PCB/60 wt % UF | |
| Untreated 50 wt % PCB/50 wt % UF | 74.7 |

Results of water absorption test indicated that MDF absorbed the most water at 27.7%, and turned the water colour to an orange tint, whereas all other samples absorbed less than 16% water and had no colour change within the water. This absorption is due to the greater permeability and porosity of wood fibres as compared to the E-waste fibres within the composite. A comparison is shown below in Table 16.

TABLE 16

| Batch | % Water Absorption |
|---|---|
| MDF | 27.7 |
| Neat (100%) UF | 9.0 |
| 50 wt % PCB coarse fraction + 50 wt % | 15.6 |
| UF | |
| 50 wt % ICCP + 50 wt % UF | 12.7 |
| 40 wt % PCT coarse fraction silane | 6.2 |
| treated + 60 wt % UF | |

E-waste reinforced composites maintained excellent mechanical properties, and even exceeded anti-swelling properties, comparable to those commercially available MDF boards.

### General

In the preceding description, for purposes of explanation, numerous details are set forth in order to provide a thorough understanding of the embodiments. However, it will be apparent to one skilled in the art that these specific details are not required. In other instances, well-known structures and components are shown in block diagram form in order not to obscure the understanding.

The above-described embodiments are intended to be examples only. Alterations, modifications and variations can be effected to the particular embodiments by those of skill in the art. The scope of the claims should not be limited by the particular embodiments set forth in the examples, but should be given the broadest interpretation consistent with the specification as a whole.

All publications, patents and patent applications are herein incorporated by reference in their entirety to the same extent as if each individual publication, patent or patent application was specifically and individually indicated to be incorporated by reference in its entirety. Where a term in the present disclosure is found to be defined differently in a document incorporated herein by reference, the definition provided herein is to serve as the definition for the term.

While the present disclosure has been described with reference to examples, it is to be understood that the scope of the claims should not be limited by the embodiments set forth in the examples, but should be given the broadest interpretation consistent with the description as a whole.

The present disclosure relates to an electronic waste (E-waste) recycling process and composite article or material using the E-waste. E-waste, for example including printed circuit boards (PCBs) and/or electronic components (ECs) such as integrated circuit (IC) chips, is size reduced, processed with one or more chemicals to remove base metals, precious metals, and chemicals of concern, and dried to provide a E-waste powder. The E-waste powder, may be used to form an E-waste composite article or material.

### FULL CITATIONS FOR DOCUMENTS REFERRED TO IN THE DISCLOSURE

¹ J. Mardsen, I. House, The Chemistry of Gold Extraction. 1992, West Sussex, England.
² E. B. Amey, “Gold” USGS Mineral Yearbook 2004 (Washington, D.C., USGS, 2004), pp. 34.1-34.9 and https://www.statista.com/statistics/238414/global-gold-production-since-2005/.
³ (a) Anonymous, “Gold” Mining Journal, (Jun. 11, 2004), pp. 19-24; (b) (https://www.nrcan.gc.ca/our-natural-resources/minerals-mining/minerals-metals-facts/gold-facts/20514).
⁴ Dai, X., Breuer, P. L., Jeffrey, M. I. Minerals & Metallurgical Processing, 2010, 27, 190-195.
⁵ M. D. Adams, B. Sceresini, Elsevier, 2005, 789-824.
⁶ “European Union Risk Assessment Report: 2,2′,6,6′-tetrabromo-4,4′-isopropylidenediphenol (tetrabromobisphenol-A or TBBP-A) Part II—human health,” European Chemicals Bureau, Italy, 2006, vol. 63.
⁷ S. Herat, “Environmental impacts and use of brominated flame retardants in electrical and electronic equipment,” The Environmentalist, vol. 28, 12/01 2008, doi: 10.1007/s10669-007-9144-2.
⁸ Zhang CC, Zhang FS. Removal of brominated flame retardant from electrical and electronic waste plastic by solvothermal technique. J Hazard Mater. 2012 Jun. 30; 221-222:193-8. doi: 10.1016/j.jhazmat.2012.04.033. Epub 2012 Apr. 20. PMID: 22575175
⁹ See note 6.

¹⁰ K. Friedrich, “Chapter 1-Routes for achieving multifunctionality in reinforced polymers and
composite structures,” in Multifunctionality of Polymer Composites, K. Friedrich and U. Breuer Eds. Oxford: William Andrew Publishing, 2015, pp. 3-41.
¹¹ P. S. Birak and C. T. Miller, “Dense non-aqueous phase liquids at former manufactured gas plants: Challenges to modeling and remediation,” Journal of Contaminant Hydrology, vol. 105, no. 3, pp. 81-98, 2009 Apr. 1/2009, doi: https://doi.org/10.1016/j.jconhyd.2008.12.001.
¹² G. Banhegyi, “What is the difference between compatibilizer and coupling agents for polymer composites?,” vol. 2021, ed. ResearchGate, 2014.
¹³ W. Gul, A. Khan, and A. Shakoor, “Impact of Hot Pressing Temperature on Medium Density Fiberboard (MDF) Performance”, Hindawi Publishing Corporation Advances in Materials Science and Engineering Volume 2017, Article ID 4056360, https://doi.org/10.1155/2017/4056360, FIG. 1, p. 2.
¹⁴ V. Beiser, “Why the world is running out of sand,” in BBC Future, ed: British Broadcasting Corporation 2019.
¹⁵ E. E. Gdoutos, Fracture Mechanics: An Introduction, 2nd ed. (Solid Mechanics and Its Applications). Dordrecht: Springer Netherland, 2005.

1. A process for preparing an E-waste powder comprising:
processing E-waste particles into a slurry;
extracting one or more base metal by chemical leaching; extracting one or more precious metal by chemical leaching; and drying the slurry to provide the E-waste powder.

2. The process of claim 1, further comprising subjecting E-waste to a size reducing step to produce the E-waste particles.

3. The process of claim 2, wherein the E-waste particles have an average particle size between about 1 and about 1000 microns, between about 100 μm and about 300 μm, between about 100 μm and about 250 μm, or about 250 μm.

4. The process of claim 1, wherein the E-waste comprises populated printed circuit boards (PCBs), electronic components (ECs), and/or depopulated printed circuit boards (PCBs).

5. The process of claim 1, further comprising:
leaching the E-waste particles with sulfuric acid, before extracting the one or more base metal and/or before extracting the one or more precious metal; and/or
leaching the E-waste particles with hydrochloric acid (HCl) before the drying.

6. (canceled)

7. The process of claim 1, further comprising forming a composite article or a composite material by combining:
the E-waste powder and a binder;
the E-waste powder and a thermoplastic;
the E-waste powder and a thermoset plastic; or
the E-waste powder and another material.

8. The process of claim 1, wherein the E-waste powder is combined with a plastic, or cement or bitumen based composite.

9. The process of claim 8, wherein the plastic comprises one or more of polypropylene (PP), copolymer polypropylene (CoPP), high density polyethylene (HOPE), urea formaldehyde (UF) and polyurethane (PU).

10. The process of claim 8, wherein the E-waste powder is combined with a thermoplastic or thermoset polymer.

11. The process of claim 1, further comprising preparing a masterbatch from the E-waste powder.

12. The process of claim 1, further comprising forming a composite article or material comprising the E-waste powder.

13. The process of claim 1, wherein extracting one or more precious metal comprises adding one or more chemical to leach at least one of the one or more precious metals into solution and separating the solution and the slurry.

14. The process of claim 1, wherein the one or more precious metal comprises gold, silver, platinum group metals (PGMs), or combinations thereof.

15. The process of claim 12, wherein the forming comprises blending the E-waste powder with a base plastic for injection molding or compression molding the composite article.

16. The process of claim 7, wherein the composite article comprises a composite board, panel, decking, or structural beam.

17. The process of claim 7, wherein the forming comprises:
blending the E-waste powder with a binder and hemp to provide the composite material; or
injection molding or compression molding.

18. (canceled)

19. The process of claim 1, wherein the drying comprises one or more of:
solid-liquid extraction;
density separation;
filtering;
heating; and/or
maintaining an elevated temperature for a period of time.

20. The process of claim 1, further comprising removing one or more chemical of concern (CoC).

21. The process of claim 20, wherein one or more chemical of concern comprises a brominated flame retardant (BFR).

22. The process of claim 1, further comprising applying a surface treatment to the E-waste powder.

23. The process of claim 22, wherein the surface treatment comprises applying a coupling agent and/or a compatibilizer.

24. An E-waste powder produced by the process of claim 1.

25. A masterbatch composite produced by the process of claim 10.

26. A composite article or composite material produced by the process of claim 1.

27. A process for preparing a catalyst waste powder comprising:
processing catalyst waste particles into a slurry;
extracting one or more base metal by chemical leaching;
extracting one or more precious metal by chemical leaching; and
drying the slurry to provide the catalyst waste powder.

28. The process of claim 27, further comprising subjecting catalyst waste to a size reducing step to produce the catalyst waste particles.

29. The process of claim 28, wherein the catalyst waste particles have an average particle size between about 1 and about 1000 microns, between about 100 μm and about 300 μm, between about 100 μm and about 250 μm, or about 250 μm.

30. The process of claim 27, further comprising forming a composite article or material comprising the catalyst waste powder.

31. The process of claim 27, wherein the catalyst waste powder is combined with a plastic, or cement or bitumen based composite.

32. A catalyst waste powder produced by the process of claim 27.

33. A composite article or composite material produced by the process of claim 27.
